(19) United States
(12) Patent Application Publication
(10) Pub. No.: US 2023/0419182 A1
(43) Pub. Date: Dec. 28, 2023

(54) METHODS AND SYSTEMS FOR IMRPOVING A PRODUCT CONVERSION RATE BASED ON FEDERATED LEARNING AND BLOCKCHAIN

(71) Applicant: HANGZHOU TONGHUASHUN DATA PROCESSING CO., LTD., Hangzhou (CN)

(72) Inventors: Lulu WEN, Hangzhou (CN); Ming CHEN, Hangzhou (CN); Yongfei BAO, Hangzhou (CN); Tianyi MA, Hangzhou (CN); Yilin YAO, Hangzhou (CN)

(73) Assignee: HANGZHOU TONGHUASHUN DATA PROCESSING CO., LTD., Hangzhou (CN)

(21) Appl. No.: 18/321,242

(22) Filed: May 22, 2023

(30) Foreign Application Priority Data
Jun. 27, 2022 (CN) 202210732210.4

(51) Int. Cl. G06N 20/00

(52) U.S. Cl. CPC G06N 20/00

(57) ABSTRACT

The present disclosure provides systems and methods for improving a product conversion rate based on federated learning and blockchain. The system may in response to receiving a federated learning request sent by an initiator node, broadcast the federated learning request within a blockchain federation; in response to obtaining a response to the federated learning request from at least one node in the blockchain federation, determine at least one participant node; obtain first representation data related to first user data from the initiator node and second representation data related to second user data from the at least one participant node; determine a federated learning strategy corresponding to the federated learning request based on the first representation data and the second representation data; and coordinate the initiator node and the at least one participant node for federated learning based on the federated learning strategy to generate a trained conversion rate model.

### CROSS-REFERENCE TO RELATED APPLICATIONS

This application claims priority of Chinese Patent Application No. 202210732210.4, filed on Jun. 27, 2022, the contents of which are hereby incorporated by reference to its entirety.

### TECHNICAL FIELD

The present disclosure relates to the field of secure multi-party computation, and in particular to a method and system for improving a product conversion rate based on federated learning and blockchain.

### BACKGROUND

In some application scenarios, a model can be trained by federation learning with multi-party participation. For example, when the accuracy of a conversion rate model cannot be improved as the limitation of the number of users and/or the number of sample features in user data for the reason, the conversion rate model can be trained by the federated learning with multi-party participation. In addition, in the federation learning with multi-party participation, the data in the federation learning needs to be secured due to data security demands.

Therefore, it is desired to provide a method and system for improving a product conversion rate based on federated learning and blockchain, which can better achieve the federated learning with multi-party participation, as well as can protect the data security in the federated learning.

### SUMMARY

One aspect of the present disclosure provides a method for improving a product conversion rate based on federated learning and blockchain. The method may be applied to a supervisor node. The method may include: in response to receiving a federated learning request sent by an initiator node, broadcasting the federated learning request within a blockchain federation, the initiator node storing first user data; in response to obtaining a response to the federated learning request from at least one node in the blockchain federation, determining at least one participant node, wherein each participant node stores second user data; obtaining first representation data related to the first user data from the initiator node and second representation data related to the second user data from the at least one participant node; determining a federated learning strategy corresponding to the federated learning request based on the first representation data and the second representation data; and coordinating the initiator node and the at least one participant node for federated learning based on the federated learning strategy to generate a trained conversion rate model, the trained conversion rate model being configured to determine, based on user data of a target user, a prediction outcome of the target user obtaining a preset product.

Another aspect of the present disclosure provides a system for improving a product's conversion rate based on federal learning and blockchain. The system may include at least one storage medium and at least one processor. The storage medium may include an instruction set configured to improve the product conversion rate based on the federated learning and the blockchain. The at least one processor may be in communication with the at least one storage medium. When executing the instruction set, the at least one processor may be configured to: in response to receiving a federated learning request sent by an initiator node, broadcast the federated learning request within a blockchain federation, the initiator node storing first user data; in response to obtaining a response to the federated learning request from at least one node in the blockchain federation, determine at least one participant node, wherein each participant node stores second user data; obtain first representation data related to the first user data from the initiator node and second representation data related to the second user data from the at least one participant node; determine a federated learning strategy corresponding to the federated learning request based on the first representation data and the second representation data; and coordinate the initiator node and the at least one participant node for federated learning based on the federated learning strategy to generate a trained conversion rate model, the trained conversion rate model being configured to determine, based on user data of a target user, a predicted outcome of the target user obtaining a preset product.

Another aspect of the present disclosure provides a non-transitory computer-readable storage medium storing computer instructions. When the computer instructions are executed by a processor, a method for improving a product conversion rate based on federated learning and blockchain may be implemented. The method may include: in response to receiving a federated learning request sent by an initiator node, broadcasting the federated learning request within a blockchain federation, the initiator node storing first user data; in response to obtaining a response to the federated learning request from at least one node in the blockchain federation, determining at least one participant node, wherein each participant node stores second user data; obtaining first representation data related to the first user data from the initiator node and second representation data related to the second user data from the at least one participant node; determining a federated learning strategy corresponding to the federated learning request based on the first representation data and the second representation data; and coordinating the initiator node and the at least one participant node for federated learning based on the federated learning strategy to generate a trained conversion rate model, the trained conversion rate model being configured to determine, based on user data of a target user, a prediction outcome of the target user obtaining a preset product.

Another aspect of the present disclosure provides a system for improving a product conversion rate based on federal learning and blockchain. The system may include a blockchain federation including: an initiator node configured to initiate a federated learning request, the initiator node storing first user data; at least one participant node configured to receive the federated learning request, each participant node storing second user data; and a supervisor node in communication with the initiator node and the at least one participant node, wherein the supervisor node is configured to: obtain first representation data related to the first user data from the initiator node and second representation data related to the second user data from the at least one participant node; determine a federated learning strategy corresponding to the federated learning request based on the first representation data and the second representation data; and coordinate the initiator node and the at least one participant node for federated learning based on the federated learning strategy to generate a trained conversion rate model, the trained conversion rate model being configured to determine, based on user data of a target user, a predicted outcome of the target user obtaining a preset product.

### BRIEF DESCRIPTION OF THE DRAWINGS

The present disclosure is further illustrated in terms of exemplary embodiments. These exemplary embodiments are described in detail with reference to the drawings. These embodiments are not limited. In these embodiments, the same number represents the same structure, wherein:

FIG. 1 is a schematic diagram illustrating an application scenario of a system for improving a product conversion rate based on federal learning and blockchain according to some embodiments of the present disclosure;

FIG. 2 is a block diagram illustrating an exemplary system for improving a product conversion rate based on federated learning and blockchain according to some embodiments of the present disclosure;

FIG. 3 is a flowchart illustrating an exemplary method for improving a product conversion rate based on federated learning and blockchain according to some embodiments of the present disclosure;

FIG. 4 is a schematic flowchart illustrating a longitudinal federated learning according to some embodiments of the present disclosure;

FIG. 5 is a schematic flowchart illustrating a horizontal federated learning according to some embodiments of the present disclosure; and

FIG. 6 is a flowchart illustrating an exemplary process for determining a training reward according to some embodiments of the present disclosure.

### DETAILED DESCRIPTION

The technical schemes of embodiments of the present disclosure will be more clearly described below, and the accompanying drawings need to be configured in the description of the embodiments will be briefly described below. Obviously, the drawings in the following description are merely some examples or embodiments of the present disclosure, and will be applied to other similar scenarios according to these accompanying drawings without paying creative labor. Unless obviously obtained from the context or the context illustrates otherwise, the same numeral in the drawings refers to the same structure or operation.

It should be understood that the terms “system,” “device,” “unit,” and/or “module” used herein is a manner for distinguishing different components, elements, components, parts or assemblies of different levels. However, if other terms may achieve the same purpose, the terms may be replaced by other expressions. As shown in the present disclosure and claims, unless the context clearly prompts the exception, “a”, “one”, and/or “the” is not specifically singular, and the plural may be included. It will be further understood that the terms “comprise,” “comprises,” and/or “comprising,” “include,” “includes,” and/or “including,” when used in present disclosure, specify the presence of stated features, integers, steps, operations, elements, and/or components, but do not preclude the presence or addition of one or more other features, integers, steps, operations, elements, components, and/or groups thereof. In the present disclosure, the symbol { } may represent a set. For example, for the set {Xᵢ^{A}, Yᵢ^{A}}, i ∈ D_{E}, each element within the set may be determined based on the corresponding i value, and each element specifically includes the corresponding vector Xᵢ^{A} and the vector Yᵢ^{A}. The symbol [[ ]] may represent a homomorphic encryption algorithm, for example, the data [[u^{b}]] may represent the variable u b after a homomorphic encryption.

The flowcharts are used in present disclosure to illustrate the operations performed by the system according to the embodiment of the present disclosure. It should be understood that the preceding or following operations is not necessarily performed in order to accurately. Instead, the operations may be processed in reverse order or simultaneously. Moreover, one or more other operations may be added to the flowcharts. One or more operations may be removed from the flowcharts.

A model to be trained in the federated learning may also be referred to as a federated learning model.

Some embodiments of the present disclosure provide a method and system for improving a product conversion rate based on federated learning and blockchain, wherein a federated learning with multi-party participation is achieved securely through the interaction of various nodes, which can effectively improve a model application effect, for example, a model effect such as an accuracy of a conversion rate model can be improved, making the conversion rate model have a better business application effect. In some embodiments, an initiator of the federated learning may provide the federated learning model, and a participant may use its own stored data to assist the initiator in training the federated learning model.

Some embodiments of the present disclosure provide a method and system for improving a product conversion rate based on federated learning and blockchain. The system may also determine an accuracy improvement of the federated learning model after performing the federated learning through a data interaction of each node, and achieve a reasonable evaluation of the execution of the federated learning. The system may also determine a reward of each participant node based on the accuracy improvement of the federal learning model improved by the training data of each participant node, which in turn may achieve an effective improvement of the motivation of each participant in the federal learning and help improve the model training effect.

The method and system for improving a product conversion rate based on federated learning and blockchain disclosed in some embodiments of the present disclosure may be applied to various machine learning models such as a conversion rate model, a prediction model in other business applications, etc. For illustration purposes, some embodiments of the present disclosure describe the system and method for improving a product conversion rate based on federated learning and blockchain mainly by using the conversion rate model as an example.

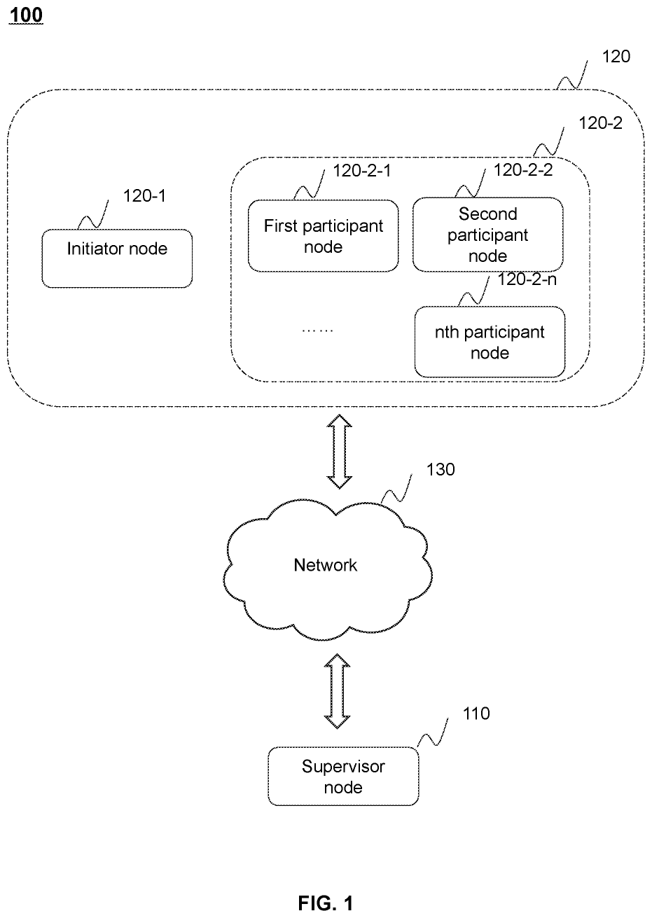

FIG. 1 is a schematic diagram illustrating an application scenario 100 of an exemplary system for improving a product conversion rate based on federal learning and blockchain according to some embodiments of the present disclosure.

In some embodiments, the system for improving a product conversion rate based on federated learning and blockchain may be implemented by implementing methods and/or processes disclosed in the present disclosure to perform a federated learning and allocate a training reward.

In some embodiments, the system for improving a product conversion rate based on federated learning and blockchain may be applied to various scenarios where there are training demands and an accuracy of a conversion rate model cannot be improved for reasons limited by the number of users and/or the number of sample features in user data. In some embodiments, the conversion rate model may be configured to obtain a prediction outcome of a user obtaining a preset product based on user data (e.g., browsing, searching, and other behavioral data on a service platform) of a user (also be referred to as a target user). The obtaining a preset product may refer to an act of buying, selecting, watching, etc. the preset product, etc., e.g., the obtaining a preset product may refer to buying a product, watching a video, etc.) For example, a probability of the user obtaining the preset product, which may be configured to recommend a product to the user (e.g., a user with a higher probability may be a potential customer of the preset product, and the preset product may be recommended to the user). Recommendation of a product to the user with a higher probability of obtaining the preset product can improve the recommendation effect of users of each participant.

In some embodiments, as shown in FIG. 1, the application scenario 100 of the system for improving a product conversion rate based on federated learning and blockchain may include a supervisor node 110, member nodes 120, and a network 130.

The supervisor node 110 and the member nodes 120 may form a blockchain federation. In some embodiments, each node in the blockchain federation may be determined based on an actual application scenario. For example, when the application scenario 100 of the system for improving a product conversion rate based on federated learning and blockchain is applied in a federated learning in the field of finance, the supervisor node 110 may represent a third-party platform (e.g., a financial regulator) and the member nodes 120 may represent various financial institutions (e.g., a bank, a security company, etc.).

The supervisor node 110 may refer to a coordination platform of the system for improving a product conversion rate based on federated learning and blockchain, and the supervisor node 110 may communicate with various relevant nodes to coordinate the execution of a federated learning task while conducting the federated learning. For example, the supervisor node 110 may communicate with the member nodes 120 to determine an intermediate result of the federated learning process. In some embodiments, the supervisor node 110 may participate in the federated learning task. For example, the supervisor node 110 may determine a federal learning strategy corresponding to a federal learning request based on first representation data and second representation data. The supervisor node 110 may coordinate the federal learning with an initiator node and at least one participant node based on the federal learning strategy to generate a trained conversion rate model. The trained conversion rate model may be configured to determine, based on the user data of the target user, a prediction outcome of the target user obtaining the preset product.

The member nodes 120 may refer to various participant platforms that perform the federated learning in the system for improving a product conversion rate based on federated learning and blockchain. In some embodiments, at least a portion of the member nodes 120 may be involved in the federated learning process. For example, as shown in FIG. 1, in a federation learning, the member nodes 120 may include an initiator node 120-1 and at least one participant node 120-2 (e.g., a first participant node 120-2-1, a second participant node 120-2-2, nth participant node 120-2-n).

The initiator node 120-1 may be an initiator node of the federal learning. In some embodiments, the initiator node 120-1 may send a federal learning request to the supervisor node 110 to cause the supervisor node 110 to start the federal learning based on the federal learning request.

The participant nodes may refer to at least a portion of the member nodes participating in the federated learning. In some embodiments, in response to the initiator node 120-1 sending the federated learning request to the supervisor node 110, the supervisor node 110 may broadcast the federated learning request to various member nodes 120 other than the initiator node 120-1. In response to obtaining a response to the federated learning request from at least one node in the blockchain federation, the supervisor node 110 may determine at least one participant node 120-2. In some embodiments, different blockchain federations may be formed depending on different industries to which the members belong. For example, various different streaming platforms may form a blockchain federation, and thus a recommendation algorithm may be improved to improve the quality of video recommendations according to the method for improving a product conversion rate based on federated learning and blockchain provided in some embodiments of the present disclosure. As another example, various different shopping platforms may form a blockchain federation, and thus a recommendation algorithm may be improved to improve the quality of product recommendations according to the method for improving a product conversion rate based on federated learning and blockchain provided in some embodiments of the present disclosure.

In some embodiments, members of different industries may form a blockchain federation. Since each member has its corresponding tag, each member who participates in the blockchain federation may store its respective tag on the blockchain federation. In response to the members of different industries forming the blockchain federation, the initiator node 120-1 may need to bring a specified tag type when initiating a federal learning request, and then the supervisor node 110 may broadcast to each member node 120 other than the initiator node 120-1 corresponding to the specified tag type in the blockchain federation to improve the broadcasting efficiency and enhance a response rate. Alternatively, the supervisor node 110 may broadcast to all member nodes 120 other than the initiator node 120-1 and bring the specified label type in a broadcast message. Upon obtaining a response to the federal learning request from at least one node in the blockchain federation, the supervisor node 110 may verify a tag corresponding to the at least one node to determine whether the tag is the specified tag type. In response to determining that the tag is not the specified tag type, the supervisor node 110 may reject the participation of that member.

In some embodiments, the supervisor node 110 and the member nodes 120 may be configured as smart devices with high computing power to perform the method for improving a product conversion rate based on federated learning and blockchain. For example, the supervisor node 110 and the member nodes 120 may typically contain computer common components such as a processor, a storage device, etc.

The processor may be configured to process data related to the system for improving a product conversion rate based on federated learning and blockchain. For example, in response to a processor of the supervisor node 110 receiving a federated learning request sent by the initiator node 120-1, the processor of the supervisor node 110 may broadcast the federated learning request within the blockchain federation. Further, in response to the processor of the supervisor node 110 obtaining a response to the federal learning request from at least one node in the blockchain federation, the processor of the supervisor node 110 may determine at least one participant node 120-2. Next, the processor of the supervisor node 110 may obtain first representation data related to first user data from the initiator node 120-1 and second representation data related to second user data from the at least one participant node 120-2, and determine a federated learning strategy corresponding to the federated learning request based on the first representation data and the second representation data. Finally, the processor of the supervisor node 110 may coordinate the initiator node 120-1 and the at least one participant node 120-2 for federated learning based on the federated learning strategy to generate a trained conversion rate model. The trained conversion rate model may be configured to determine, based on user data of a target user, a prediction outcome of the target user obtaining a preset product. In some embodiments, the processor may be a single server or a group of servers. The group of servers may be centralized or distributed. In some embodiments, the processor may be local or remote. In some embodiments, the processor may be implemented on a cloud platform. By way of example only, the cloud platform may include a private cloud, a public cloud, a hybrid cloud, a community cloud, a distributed cloud, an internal cloud, a multi-tier cloud, or any combination thereof.

The storage device may store data, instructions, and/or any other information. In some embodiments, the storage device may store data and/or instructions related to an improvement of a product conversion rate based on federated learning and blockchain. For example, a storage device of the initiator node 120-1 may store the first user data. As another example, the storage device of each participant node 120-2 may store the second user data. In some embodiments, the storage device may be connected to the network 130 to communicate with one or more other components (e.g., a processor) in the application scenario 100 of the system for improving a product conversion rate based on federated learning and blockchain. One or more components of the application scenario 100 of the system for improving a product conversion rate based on federated learning and blockchain may access data or instructions stored in the storage device via the network 130. In some embodiments, the storage device may be part of the processor.

The network 130 may connect the one or more components of the application scenario 100 of the system for improving a product conversion rate based on federated learning and blockchain and/or connect external resource components of the application scenario 100 of the system for improving a product conversion rate based on federated learning and blockchain. The network may be configured to achieve communications between the components of the application scenario 100 and communications between the components of the application scenario 100 o and other external components of the application scenario 100, facilitating data and/or information exchange. For example, the member nodes 120 may be connected to the supervisor node 110 via the network 130. As another example, various nodes within the member nodes 120 may communicate via the network 130.

In some embodiments, the network 130 may be a wired network and/or a wireless network. In some embodiments, the network 130 may include one or more network access points. For example, the network 130 may include a wired or wireless network access point, a base station, a switching point, etc. In some embodiments, the switching point may be a communication base station, e.g., a mobile communication network, an Internet, a local area network (LAN), a wide area network (WAN), a wireless local area network (WLAN), etc. In some embodiments, the network 130 may include a variety of topologies such as a point-to-point topology, a shared topology, a centralized topology, or a combination thereof.

In some embodiments, when communicating over the network 130, each node in the blockchain federation may transmit data based on a multi-party secure computing protocol to ensure data security of each node. For example, the supervisor node 110 may create an asymmetric encryption key pair based on the multi-party secure computing protocol and send a public key of a symmetric encryption key pair to each member node 120 of the application scenario 100 of the system for improving a product conversion rate based on federated learning and blockchain. The asymmetric encryption key pair may include a public key for encryption and a private key for decryption, and data encrypted based on the public key may need to be decrypted based on the private key. When a member node (e.g., the initiator node 120-1) sends data to the supervisor node 110, the data may be encrypted based on the public key issued by the supervisor node 110, and the supervisor node 110 may decrypt the encrypted data based on the private key after receiving the data.

It should be noted that the application scenario is provided for illustrative purposes only and is not intended to limit the scope of the present disclosure. For those skilled in the art, a variety of modifications or variations can be made based on the description of the present disclosure. For example, the application scenario may also include a database. As another example, the application scenario may be implemented on other devices to achieve similar or different functionality. However, the variations and modifications do not depart from the scope of the present disclosure.

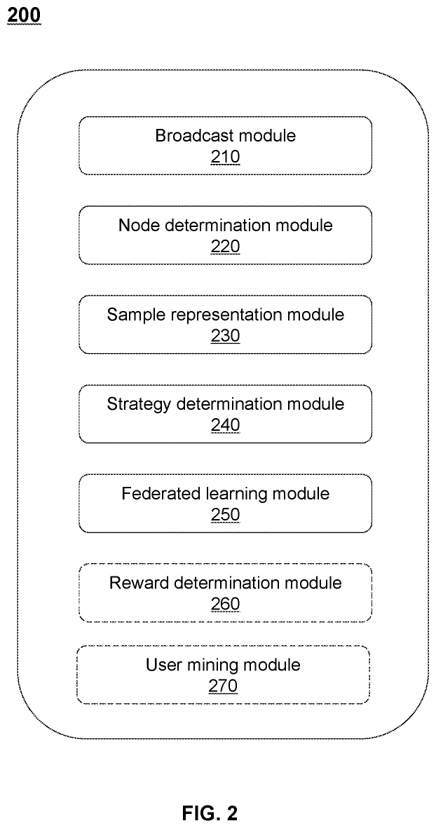

FIG. 2 is a module diagram illustrating an exemplary system for improving a product conversion rate based on federated learning and blockchain according to some embodiments of the present disclosure.

As shown in FIG. 2, a federated learning supervision system 200 of the blockchain federation may include a broadcast module 210, a node determination module 220, a sample representation module 230, a strategy determination module 240, and a federated learning module 250. In some embodiments, the federated learning supervision system 200 of the blockchain federation may also include a reward determination module 260 and a user mining module 270. In some embodiments, the federal learning supervision system 200 of the blockchain federation may act as a third party (e.g., the supervisor node 110) of the blockchain federation to coordinate the federal learning by various member nodes of the blockchain federation.

The broadcast module 210 may be configured to broadcast a federal learning request within the blockchain federation in response to receiving the federal learning request from the initiator node. The initiator node may store first user data. In some embodiments, the federal learning request may include an initial training reward. The initial training reward may include a federal learning service fee and a total training reward of each participant node.

The node determination module 220 may be configured to determine at least one participant node in response to obtaining a response to the federal learning request from at least one node in the blockchain federation, wherein each participant node has second user data stored.

The sample representation module 230 may be configured to obtain first representation data related to the first user data from the initiator node and second representation data related to the second user data from the at least one participant node.

The strategy determination module 240 may be configured to determine a federal learning strategy corresponding to the federal learning request based on the first representation data and the second representation data. In some embodiments, the strategy determination module 240 may further be configured to determine a feature dimension similarity and a sample repetition based on the first representation data and the second representation data; and determine a federal learning strategy from a longitudinal federal learning strategy and a horizontal federal learning strategy based on the feature dimension similarity and the sample repetition.

The federated learning module 250 may be configured to coordinate the initiator node and the at least one participant node for federated learning based on the federated learning strategy to generate a trained conversion rate model. The trained conversion rate model may be configured to determine, based on user data of a target user, a prediction outcome of the target user obtaining a preset product.

In some embodiments, when the longitudinal federated learning strategy is used as the federated learning strategy, the federated learning module 250 may further be configured to determine a first training sample set based on the first representation data and the second representation data. Each training sample in the first training sample set may exist in both the first user data and the second user data. The federated learning module 250 may further be configured to send the first training sample set to the initiator node and the at least one participant node, such that the initiator node and the at least one participant node can determine corresponding training data based on the first training sample set respectively, and perform at least one round of model training based on the training data. In each round of model training, the federated learning module 250 may further be configured to obtain intermediate results of the round of model training. The intermediate results may be determined, based on a same training sample in the first training sample set and corresponding representation data, by the initiator node and the at least one participant node respectively. The federated learning module 250 may further be configured to determine iteration parameters of the initiator node and the at least one participant node based on the intermediate results and send the iteration parameters to corresponding nodes, such that the initiator node and the at least one participant node can iterate the conversion rate model based on the iteration parameters.

In some embodiments, when the horizontal federated learning strategy is used as the federated learning strategy, the federated learning module 250 may further be configured to determine a second training sample set based on the first representation data and the second representation data. The second training sample set may include the first user data and non-overlapping training samples of the second user data. The federated learning module 250 may further be configured to send the second training sample set to the initiator node and the at least one participant node, such that the initiator node and the at least one participant node can determine corresponding training data based on the second training sample set respectively, and perform at least one round of model training based on the training data. In each round of model training, the federated learning module 250 may further be configured to obtain iteration parameters of the round of model training. The iteration parameters may be determined based on different training samples from the second training sample set by the initiator node and the at least one participant node respectively. The federated learning module 250 may further be configured to determine joint iteration parameters based on the iteration parameters and send the joint iteration parameters to the initiator node and each participant node, such that the initiator node and the each participant node can iterate the conversion rate model based on the joint iteration parameters, respectively.

The reward determination module 260 may be configured to determine a training reward of each participant node based on a first accuracy of the trained conversion rate model, and write the training reward to the blockchain. In some embodiments, the federated learning request may include a model accuracy improvement goal. The reward determination module 260 may further be configured to obtain a second accuracy of the federated learning related to the conversion rate model that is determined based on the first user data; determine a total training reward based on the first accuracy, the second accuracy, and the model accuracy improvement goal; and determine the training reward of each participant node based on the total training reward. In some embodiments, the determining the training reward of the each participant node based on the total training reward includes: determining a contribution degree of the each participant node; and determining the training reward of each participant node by allocating, based on the contribution degree of the each participant node, the total training reward proportionally.

In some embodiments, the user mining module 270 may be configured to receive user data to be mined sent by the initiator node. The user mining module 270 may also be configured to determine, at least based on the user data to be mined, a processing result of the user data to be mined by the conversion rate model. The user mining module 270 may further be configured to send the processing result to the initiator node.

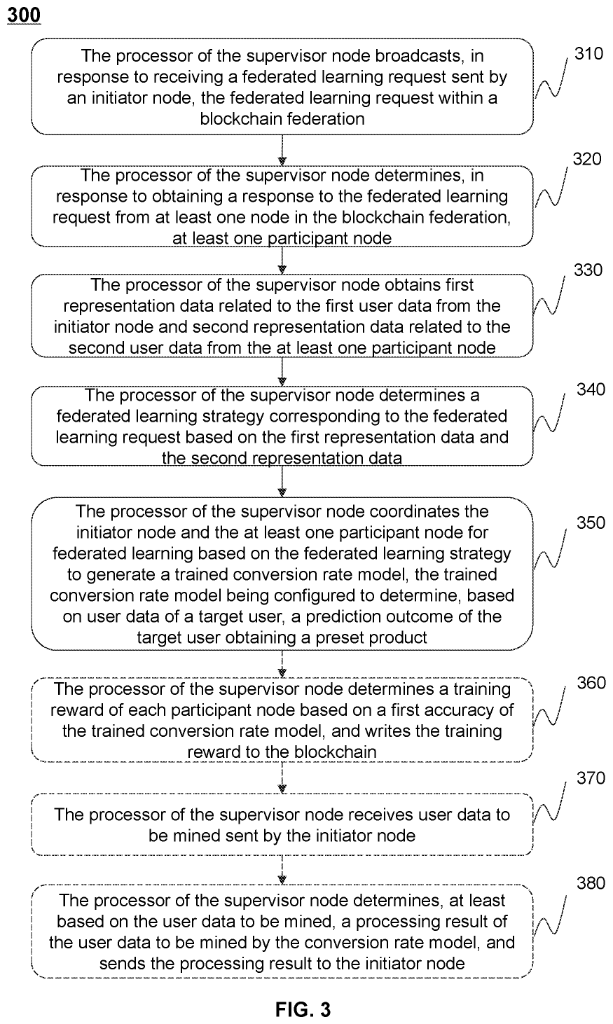

For more information about the broadcast module 210, the node determination module 220, the sample representation module 230, the strategy determination module 240, the federation learning module 250, the reward determination module 260, and the user mining module 270, please refer to FIGS. 3-6 and relevant descriptions thereof.

It should be noted that the above description of the supervisor node and its modules is for illustration purposes, and not intended to limit the present disclosure to the scope of the cited embodiments. For those skilled in the art, under the teaching of the principle of the system, any combination of the modules may be made or subsystems may be formed to connect to other modules without departing from the spirit of the present disclosure. In some embodiments, the broadcast module 210, the node determination module 220, the sample representation module 230, the strategy determination module 240, the federated learning module 250, the reward determination module 260, and the user mining module 270 disclosed in FIG. 2 may be different modules in a single system, or one module that can implement the functions of two or more of the above modules. For example, the modules may share a common storage module, or each module may have its own storage module. Variations such as these are within the scope of protection of the present disclosure.

FIG. 3 is a flowchart illustrating an exemplary method for improving a product conversion rate based on federated learning and blockchain according to some embodiments of the present disclosure. As shown in FIG. 3, process 300 may include operations described below. In some embodiments, one or more operations of the process 300 shown in FIG. 3 may be implemented in the application scenario 100 of the system for improving a product conversion rate based on federated learning and blockchain shown in FIG. 1. For example, the process 300 shown in FIG. 3 may be stored in the storage device of the supervisor node 110 in the form of instructions and invoked and/or executed by the processor of the supervisor node 110.

In 310, in response to receiving a federated learning request sent by an initiator node, the processor of the supervisor node may broadcast the federated learning request within a blockchain federation. In some embodiments, operation 310 may be performed by the broadcast module 210.

The federated learning, also known as a federated mechanical learning, may be a machine learning framework for joint modeling under the demand of multi-institutional compliance with the user privacy protection and government regulations. When member nodes in the blockchain federation participate in the federated learning, the member nodes may need to use their own private data as model training samples according to a multi-party secure computing protocol and realize a training of a conversion rate model under the coordination of a third-party platform (e.g., supervisor node). Under the multi-party secure computing protocol, the private data may be encrypted for privacy protection, still have the mathematical computational validity in plaintext, and do not affect the model training.

The federated learning request may include a request message from a member node in the blockchain federation for requesting other member nodes to collaborate training the model. A member node making the request may be noted as an initiator node. In some embodiments, the initiator node may store first user data. In some embodiments, the model that the federated learning request requests for collaborating training may include a conversion rate model to be trained. In some embodiments, the federated learning request may include a model to be trained (e.g., a conversion rate model), or information about a specified model to be trained (e.g., a model storage address, etc. based on which information about the model can be obtained).

In some embodiments, the initiator node may store the first user data used to train the conversion rate model. The first user data may include at least one group of training samples. Each group of training samples may include a sample feature and a sample label. The sample feature may be used as an input of the conversion rate model to determine a model output, and the sample label may be used to be computed along with the model output to determine iteration parameters of the conversion rate model.

In some embodiments, a specific content of the first user data may be determined based on the use of the conversion rate model. For example, the conversion rate model may be used to determine a probability of a customer purchasing a specific financial product, and the first user data may include a sample feature and a sample label of each financial customer. The sample feature of the financial customer may reflect relevant conditions of the customer (e.g., a deposit amount, a loan amount, a monthly fixed income, etc.), and the sample label of the financial customer may point to a purchase situation of the customer after the financial product is recommended by the customer. For example, a purchase label may be 1 and a non-purchase label may be 0.

In some embodiments, the federated learning request may include a reward for encouraging member nodes to participate in the federated learning. In some embodiments, the federated learning request may include an initial training reward. The initial training reward may be used to pay for a federated learning service fee of the supervisor node, and a total training reward of each participant node.

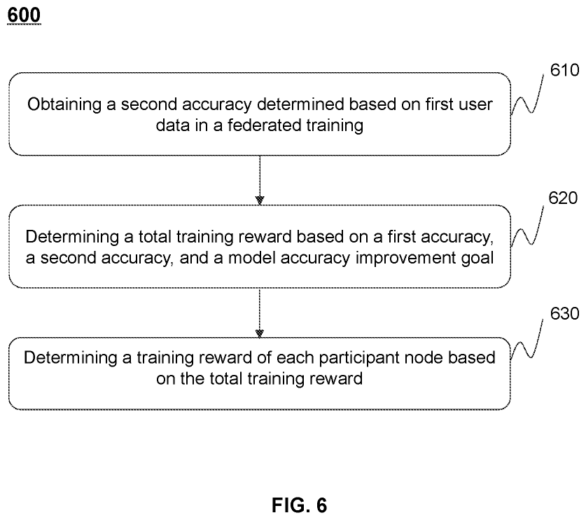

The initial training reward may refer to a total fee paid or to be paid by the initiator node for the federal learning request. The federation learning service fee may refer to a fee charged by a third party (e.g., supervisor node) associated with the federation learning. The total training reward of each participant node may refer to a total training reward allocated to each participant node after the federal learning is completed (e.g., when the trained conversion rate model satisfies a preset goal). For more information about a specific reward allocation manner of each participant node, please refer to FIG. 6 and the relevant description thereof.

In some embodiments, the initiator node may send the total fee or fee budget of the federal learning request to the supervisor node when generating the federal learning request. The supervisor node may estimate the federal learning service fee of the federal learning based on the federal learning request. Then, the supervisor node may deduct the federal learning service fee from the initial training reward and use a remaining fee as the total training reward.

In some embodiments, the initiator node may encrypt and send the conversion rate model with relevant parameters thereof (e.g., a description file of the conversion rate model, parameter demands of the conversion rate model, a federated learning goal, an initial training reward, etc.) to the supervisor node based on a public key of the supervisor node. The supervisor node may parse out the conversion rate model and relevant learning parameters based on a private key.

When the conversion rate model and the relevant parameters meet a preset condition, the supervisor node may broadcast the federated learning request to other member nodes in the blockchain federation through the federated learning request. The preset condition may be determined based on a relevant law and an actual situation (such as whether the model is trainable or not). For example, when the use of the conversion rate model does not violate the relevant law, rule, and guideline, and the conversion rate model is trainable based on the first user data, the conversion rate model and the relevant parameters may be judged to satisfy the preset condition.

In some embodiments, when broadcasting the federated learning request, the supervisor node may generate digest (or summary) information (e.g., an identification number of the federated learning request, the input and output of the conversion rate model, a parameter demand of an input feature, a training reward, etc.) based on the federated learning request and send the digest information to each member node in the form of a text, message, image, etc. to realize the broadcasting of the federated learning request.

In 320, in response to obtaining a response to the federated learning request from at least one node in the blockchain federation, the processor of the supervisor node may determine at least one participant node. In some embodiments, operation 320 may be performed by the node determination module 220.

In some embodiments, upon receiving the federal learning request, the member nodes of the blockchain federation may respond to the federal learning request to participate in the federal learning. For example, the member nodes may send a response message containing an identification number for the federal learning request to the supervisor node.

In some embodiments, each member node may include training data that is used for training the model. The supervisor node may determine a participant node by analyzing whether the training data of each member node that responds to the federated learning request can be used to train the conversion rate model.

In some embodiments, the participant node may be determined based on whether the training data includes a sample label. When training data of a member node includes the sample label, the training data of the member node may be used to train the conversion rate model. For example, the conversion rate model may be configured to determine a probability of a customer purchasing a specific financial product. The initiator node may be bank A. When a member node is bank B and the bank also issues the specific financial product, bank B may be used as a participant node.

In some embodiments, for training data that does not include the sample label, whether the training data of the member node can be used to train the conversion rate model may be determined based on a specific training sample and a sample feature. Under a condition that training data of a member node does not include the sample label, when the training sample (e.g., a specific customer) of the member node overlaps at least a portion of the training sample of the first user data and there are sample features different from sample features of the first user data, the training data of the member node may be used to train the conversion rate model. Conversely, the training data of the member node cannot be used for the federal learning. For example, for the conversion rate model configured to determine the probability of the customer purchasing a specific financial product, when the member node is bank C that does not issue the specific financial product and the customer does not overlap with bank A, training data of bank C cannot be used to train the conversion rate model. If the member node is another type of financial institution (e.g., stock exchange D) that has overlapping customers with bank A and the stock exchange D has a sample feature different from bank A (e.g., users' stock purchases, stock returns, etc.), stock exchange D may be used as a participant node.

In some embodiments, each participant node may store second user data for training the conversion rate model. The second user data may be the training data of the participant node.

In some embodiments, in response to not obtaining a response to the federated learning request from at least one node in the blockchain federation, the supervisor node may record historical participation records (e.g., response time, a contribution degree of participating the federated learning) of each node, data related to the federated learning request, and a positive degree evaluation of participation of each node, and determine a response time dynamically. For example, the supervisor node may record response times and contribution degrees of participating the federated learning of each node in historical training processes, and determine a corresponding response time asked on an average historical response time and an average contribution degree of participating the federated learning of each node. For example, the supervisor node may use

$$\frac{{\sum }_{i = 1}^{n} ( {T}_{i} \times {G}_{i} )}{n} \times 2$$

as the response time, where T i represents the average historical response time of an ith node, Gᵢ represents the average contribution degree of participating the federated learning of the ith node, and n represents the number of nodes in the blockchain federation. In some embodiments, the supervisor node may set a minimum broadcast interval and a maximum count of broadcast times to broadcast unresponsive nodes before the request ends. In some embodiments, the supervisor node may further broadcast multiple times based on a positive degree evaluation of each node and a matching degree of company type. For example, the supervisor node may broadcast multiple times (e.g., 3, 5, 8, etc.) for a node that is with a positive degree evaluation greater than a first preset threshold and a matching degree of company type greater than a second preset threshold. The first preset threshold and the second preset threshold may be set based on historical data.

In 330, the processor of the supervisor node may obtain first representation data related to the first user data from the initiator node and second representation data related to the second user data from the at least one participant node. In some embodiments, operation 330 may be performed by the sample representation module 230.

The representation data may include data that can be used to describe a data situation of the training data. The first representation data may describe a data situation of the first user data. The second representation data may describe a data situation of the second user data.

In some embodiments, the representation data may include sample identification information in the user data and a composition of sample features. For example, for the conversion rate model for determining a probability of a customer purchasing a specific financial product, the first representation data of the first user data may include identification information of each customer of bank A (e.g., a customer list including information such as a customer ID, a cell phone number, a customer ID, etc.) and a composition of sample features (e.g., each feature specifically included in the sample features in the first user data).

In some embodiments, the initiator node or participant node may process the user data stored by the node to generate representation data based on the user data. For example, the initiator node may generate identification information based on a sample list of each training sample contained in the first user data (e.g., a customer list containing an ID of a customer), and generate a composition of sample features based on feature data of the training sample. The identification information and the composition of the sample features may be used as the first representation data. Then the first representation data may be encrypted based on the public key of the supervisor node, and the encrypted data may be sent to the supervisor node.

In 340, the processor of the supervisor node may determine a federated learning strategy corresponding to the federated learning request based on the first representation data and the second representation data. In some embodiments, operation 340 may be performed by the strategy determination model 240.

The federated learning strategy may refer to a way of implementing the federated learning. In some embodiments, the federated learning strategy may include a horizontal learning strategy, a longitudinal learning strategy, or the like, or any combination thereof. The main difference between the horizontal learning strategy and the longitudinal learning strategy lies in the way of processing the second user data of the participant node.

The horizontal learning strategy may refer to an expansion of the first user data using the second user data. For example, if the initiator node includes 800 groups of training samples and the participant nodes include 200 groups of training samples, the training data of the participant nodes may be expanded using the horizontal federal learning to make a total number of training samples of 1000 groups.

The longitudinal learning strategy may refer to using the second user data to refine the first user data. For example, if the initiator node includes 200 groups of training samples, each group of training samples contains 3 sample features, and the participant nodes include the same 200 groups of training samples (e.g., the same customer ID) as the initiator node, but each group of training samples contains 2 sample features different from the first user data, the longitudinal federation learning may be performed by using the training data of the participant nodes to refine so that a total number of training samples is 200 groups and each group of training samples contains sample features.

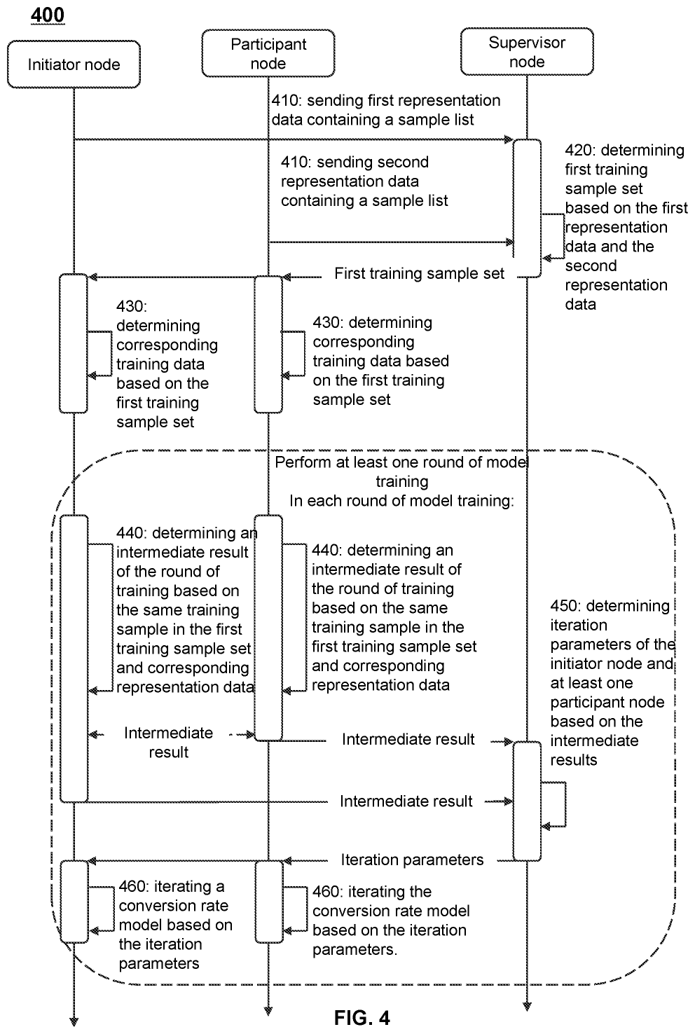

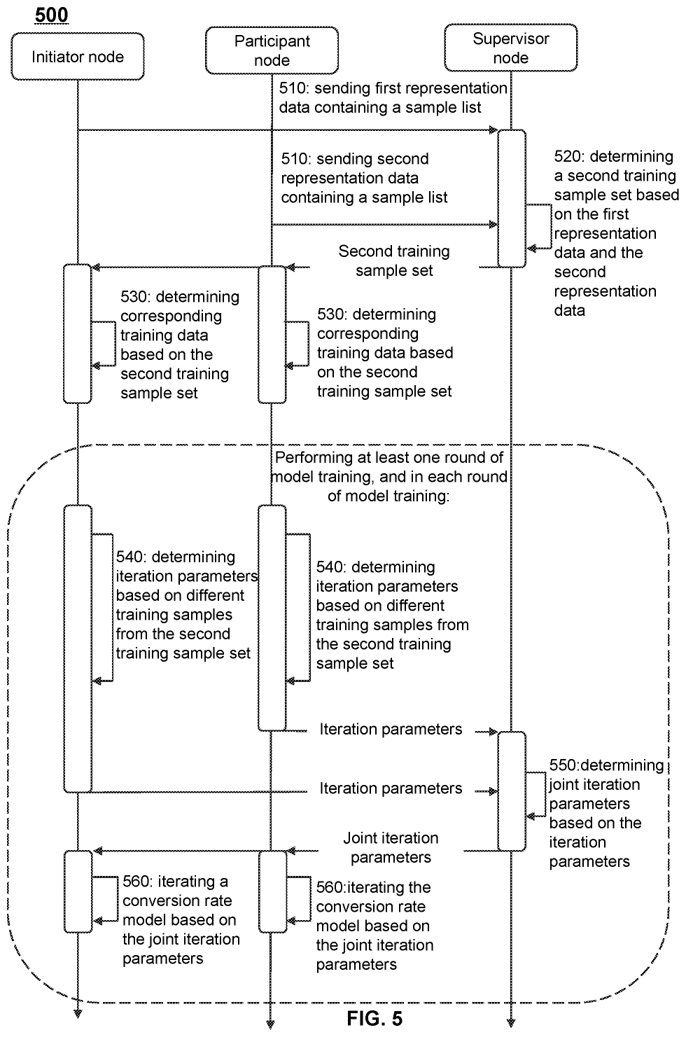

Based on the differences in the processing of the second user data, there are also differences in the methods for updating model parameters during the training process between the longitudinal learning strategy and the horizontal learning strategy. For more information about the differences, please refer to FIG. 4 and FIG. 5 for the specific operations in each round of model training and the relevant descriptions thereof.

In some embodiments, the federated learning strategy may also include a combination of the horizontal learning strategy and the longitudinal learning strategy. For example, for the conversion rate model configured to determine a probability of a customer purchasing a specific financial product, bank A may first perform the horizontal federal learning with bank B and then perform the longitudinal federal learning with stock exchange D.

In some embodiments, the federated learning strategy may be determined directly based on relevant data from the first representation data and the second representation data. For example, the relevant data of the representation data may include a situation where a sample label is present in the user data. If the sample label present in the second representation data is the same as the sample label of the first representation data, the horizontal learning strategy may generally be used. Conversely, the longitudinal learning strategy may be used.

In some embodiments, the supervisor node may also determine a feature dimension similarity and a sample repetition based on the first representation data and the second representation data. Then, the supervisor node may determine federated learning strategy from the longitudinal federated learning strategy and the horizontal federated learning strategy based on the feature dimension similarity and the sample repetition.

The feature dimension similarity may refer to a similarity between compositions of sample features in the first representation data and the second representation data. In some embodiments, the feature dimension similarity may be determined by semantics of the name of each feature. For example, if the first user data includes a deposit feature and the second user data includes a savings feature, the two features may be the same.

The sample repetition may refer to a repetition rate of sample lists in the first representation data and the second representation data. In some embodiments, the sample repetition may be determined by comparing sample identification information (e.g., customer ID, ID number, cell phone number, etc.) of the two sample lists.

For the first and second representation data with the same labels, the horizontal learning strategy may be used when the feature dimensions (e.g., the feature dimension similarity is above a threshold) are the same and the sample repetition is low. For example, for two banks in different regions with similar feature data and non-overlapping customers, the horizontal learning strategy may be used. When the feature dimension similarity is low (e.g., the second representation data has sample features that are not in the first representation data) and the sample repetition is high (e.g., the second representation data has some samples with the same ID as the first representation data), the longitudinal learning strategy may be used. For example, for different types of financial institutions (e.g., a bank and a stock exchange) in the same region, which serve basically the same customers but involve different specific financial operations and thus have different sample features, the longitudinal learning strategy may be used.

In some embodiments, the initiator node may specify a training manner as the horizontal federated learning strategy and/or the longitudinal federated learning strategy based on the first representation data. A smart contract for scoring the participant nodes may be provided on the blockchain federation. The supervisor node may send a specified training manner and the user data of at least one node that has responded to the smart contract. The smart contract may score the at least one node that has responded and record an evaluation score on the blockchain federation. Then, the supervisor node may obtain evaluation score information from the blockchain federation, and then determine the participant nodes based on a preset rule (e.g., selecting the top 3 nodes with the highest evaluation scores as participant nodes). Thus, to a certain extent, the effect of the federated training may be significantly improved, which in turn improves the effect of the federated learning, and by performing scoring by the smart contract, the trustworthiness of the scoring process may be ensured and the risk of untrustworthy scoring by the supervisor node may be avoided.

In some embodiments, the initiator node may also send training demand parameters to the smart contract. For example, when the training manner is specified as the horizontal federated learning strategy, the training demand parameters may include a condition on the number of users of the at least one node that has responded and the initiator node. For instance, the training demand parameters may include a condition that the number of users of the at least one node that have responded and be with the same features, except the existing users of the initiator node, is greater than a first preset value (e.g., 100, 300, 500, etc.). As another example, when the training manner is specified as the longitudinal federation learning strategy, the training demand parameters may include a condition on the user features of the at least one node that has responded and the initiator node. For instance, the training demand parameters may include the number of other user features of the at least one node that has responded and has the same user, except the existing user features of the initiator node, is greater than a second preset value (e.g., 3, 5, 7, etc.).

In some embodiments, the smart contract may determine an evaluation score based on the training demand parameters. For example, when the training manner is specified as the horizontal federation learning strategy, the smart contract may determine an evaluation score of the responded node based on

$$\frac{N - Y}{Y} ,$$

where N represents the number of other users with the same features of the responded node and Y represents the first preset value. N may be determined by the supervisor node based on the first representation data and the representation data related to the responded node and sent to the smart contract as information about the responded node. As another example, when the training manner is specified as the longitudinal federated learning strategy, the smart contract may determine the evaluation score of the responded node based on

$$\frac{{N}^{′} - {Y}^{′}}{{Y}^{′}} ,$$

where N′ represents the number of other users of the responded node having the same users and Y′ represents the second preset value. N′ may be determined by the supervisor node based on the first representation data and the representation data related to the responded node and sent to the smart contract as information about the responded node.

In 350, the processor of the supervisor node may coordinate the initiator node and the at least one participant node for federated learning based on the federated learning strategy to generate a trained conversion rate model. The trained conversion rate model may be configured to determine, based on user data of a target user, a prediction outcome of the target user obtaining a preset product. In some embodiments, operation 350 may be performed by the federated learning module 250.

In some embodiments, the supervisor node may determine, based on the first representation data, the second representation data, and the federated learning strategy employed, a sample set for the federated learning and allocate the sample set to the participant nodes and the initiator node, so that the participant nodes and the initiator node can determine the training data for the federated learning based on the sample set, and the federated learning may be performed.

In some embodiments, when the longitudinal federated learning strategy is used as the federated learning strategy, the supervisor node may determine a first training sample set based on the first representation data and the second representation data. Each training sample in the first training sample set may exist in both the first user data and the second user data. The supervisor node may send the first training sample set to the initiator node and the at least one participant node to cause the initiator node and the at least one participant node to determine the corresponding training data based on the first training sample set, respectively. The supervisor node may perform least one round of model training based on the training data. In each round of model training, the supervisor node may obtain intermediate results of the round of model training. The intermediate results may be determined based on a same training sample in the first training sample set and corresponding representation data by the initiator node and the at least one participant node respectively. The supervisor node may determine, based on the intermediate results, iteration parameters of the initiator node and the at least one participant node and send the iteration parameters to corresponding nodes, such that the initiator node and the at least one participant node iterate the conversion rate model based on the iteration parameters. For more about the longitudinal federated learning strategy as the federated learning strategy, please refer to FIG. 4 and its relevant description.

In some embodiments, when the horizontal federated learning strategy is used as the federated learning strategy, the supervisor node may determine a second training sample set based on the first representation data and the second representation data. The second training sample set may include the first user data and non-overlapping training samples in the second user data. The supervisor node may send the second training sample set to the initiator node and the at least one participant node, so that the initiator node and the at least one participant node can determine corresponding training data based on the second training sample set, respectively. The supervisor node may perform at least one round of model training based on the training data. In each round of model training, the supervisor node may obtain iteration parameters of the round of model training. The iteration parameters may be determined based on different training samples from the second training sample set by the initiator node and the at least one participant node respectively. The supervisor node may determine joint iteration parameters based on the iteration parameter and send the joint iteration parameters to the initiator node and each participant node, such that the initiator node and the each participant node iterate the conversion rate model based on the joint iteration parameters, respectively. For more information about the horizontal federated learning strategy as the federated learning strategy, please refer to FIG. 5 and its relevant description.

In some embodiments, the sample set may include a first sample set for training and a second sample set for testing. The first sample set may be configured to iterate parameters of the conversion rate model, and the second sample set may be configured to test the accuracy of the trained conversion rate model. The first sample set and the second sample set may be split according to a preset ratio (e.g., 8:2).

In some embodiments, for the combination of the horizontal learning strategy and the longitudinal learning strategy, the training data may be split according to the specific representation data and the horizontal federated learning may be performed before the longitudinal federated learning. For example, the second user data of the participant nodes may be split into horizontal training data and longitudinal training data. The longitudinal training data may be the second user data that overlaps with the sample identification information of the first user data.

In 360, the processor of the supervisor node may determine a training reward of each participant node based on a first accuracy of the trained conversion rate model, and write the training reward to the blockchain. In some embodiments, operation 360 may be performed by the reward determination module 260.

The blockchain may refer to an information chain consisting of multiple block information. Each block information may store a certain amount of information and be connected into a chain in the respective chronological order of the generation of the each block information. The blockchain that stores a training reward may be stored in various nodes (e.g., member nodes and third-party nodes) of the blockchain federation. When the training reward is written to the blockchain, the training reward of each participant node may be used as data stored in the block information in turn to form the blockchain.

The first accuracy of the conversion rate model may refer to an accuracy of the model output when the trained conversion rate model is tested on the second sample set. For example, the first accuracy may refer to various statistical indicators determined based on the model output and the sample label after the tested sample is input into the trained conversion rate model. For example, the first accuracy may include a probability that the model output is the same as (or within a preset range of) the sample label, statistical indicators such as an average deviation, a standard deviation, a variance, and a model confidence level between the model output and the sample label, etc.

In some embodiments, whether the federated learning is completed may be determined based on the first accuracy of the conversion rate model. For example, when the first accuracy of the conversion rate model is greater than a third preset threshold (e.g., a preset federated learning demand), the federated learning may be determined to have been completed, at which point a total training reward may be allocated to each participant node. For more information about the determining the training reward, please refer to FIG. 6 and its relevant description.

In 370, the processor of the supervisor node may receive user data to be mined sent by the initiator node. In some embodiments, operation 370 may be performed by the user mining module 270.

The user data to be mined may refer to user data to be processed stored in the initiator node. For example, for the conversion rate model configured to determine a probability of a customer purchasing a specific financial product, the user data to be mined may refer to data of customers who have not made a recommendation for the financial product.

In some embodiments, the supervisor node may receive the user data to be mined sent by the initiator node and implement the processing of the user data to be mined in the initiator node based on the trained conversion rate model.

In 380, the processor of the supervisor node may determine, at least based on the user data to be mined, a processing result of the user data to be mined by the conversion rate model, and send the processing result to the initiator node. In some embodiments, operation 380 may be performed by the user mining module 270.

The processing result of the user data to be mined may refer to a result that reflects a conversion rate of a user. For example, for the conversion rate model configured to determine a probability of a customer purchasing a specific financial product, the processing result of the user data to be mined may reflect a result of the probability of the customer purchasing the financial product after the financial product is recommended to that customer.

In some embodiments, for the conversion rate model determined based on the longitudinal federation learning, the supervisor node may determine data related to the user data to be mined from various nodes (e.g., participant nodes, etc.) in the blockchain federation based on the user data to be mined, process the user data to be mined and the relevant data based on the conversion rate model to determine the processing result of the user data to be mined, and send the processing result to the initiator node.

The relevant data of the user data to be mined may refer to relevant data of the user to be mined in the participant node. For example, for the conversion rate model for determining a probability of a customer purchasing a specific financial product, the relevant data of the user data to be mined may refer to data of the customer in the participant node.

In some embodiments, the supervisor node may first receive the user data to be mined sent by the initiator node, and then determine the relevant data of the user data to be mined from the participant node based on the user data to be mined. For example, for the conversion rate model for determining a probability of a customer purchasing a specific financial product, the initiator node may send the customer ID (e.g., name, ID number, cell phone number, etc.) of the user data to be mined to the participant node via the supervisor node, so that the participant node can determine the relevant data of the customer in the participant node based on the customer ID.

In some embodiments, the conversion rate model may be stored in the various participant nodes in a distributed manner. The supervisor node may process the user data to be mined and the relevant data based on the conversion rate model to determine the processing result of the user data to be mined and send the processing result to the initiator node. For example, for the conversion rate model for determining a probability of a customer purchasing a specific financial product, the initiator node may determine a portion of the model output (e.g., a first probability) based on a portion of the conversion rate model stored at the initiator node to process the user data to be mined and send the customer ID (e.g., name, ID number, cell phone number, etc.) of the user data to be mined to the participant node via the supervisor node, so that the participant node can determine a feature of the customer based on the customer ID and then determine a portion of the model output (e.g., a second probability) based on the feature and send the feature to the supervisor node. The supervisor node may forward a portion of the model output (e.g., the second probability) from the participant node to the initiator node to determine a final model output (e.g., a sum of the first probability and the second probability), thereby enabling customer mining.

In some embodiments, for the federated learning model determined based on the horizontal federated learning, the federated learning model may be fully stored at the initiator node, and the initiator node may directly and locally process the data to be mined to determine the model output, thus enabling customer mining.

Based on the method for improving a product conversion rate based on federated learning and blockchain provided in some embodiments of the present disclosure, a more accurate processing result of user data to be mined may be determined, and the training reward of each participant node may be reasonably determined, thereby promoting the participation of each node of the blockchain federation in the federated learning. In addition, by writing the training reward of each participant node into the blockchain and preventing tampering by relevant personnel, the fairness and the stability of the training reward system may be ensured.

It should be noted that the above description of the process 300 is for illustration purposes, and not intended to limit the scope of the present disclosure. For those skilled in the art, various variations or modifications may be made to the process 300 under the teaching of the present disclosure. However, these variations or modifications do not depart from the scope of the present disclosure. For example, operation 330 may be performed when each node firstly communicates with the supervisor node. For instance, the initiator node may send the first representation data along with a joint training request to the supervisor node. The participant node may send the second representation data to the supervisor node in response to the joint training request. As another example, operation 360 may be omitted. As still another example, operation 380 may be omitted.

In some embodiments, a process of data pre-processing may be added between operations 340-350. That is, after the supervisor node determines the federated learning strategy, the federated learning strategy and the first representation data may be sent to each participant node to enable the participant node to pre-process the second user data based on the federated learning strategy and the first representation data. For example, for each participant node involved in horizontal federal learning, a feature same or similar to the first representation data may be determined from the second user data based on the first representation data, and the second user data may be processed based on the standard of the sample features recorded in the first representation data, such that the second user data exists in the same form as the first user data. As another example, for each participant node involved in the longitudinal federation learning, features different from the first representation data may be determined from the second user data based on the first representation data. For instance, for different types of financial institutions in the same region, some of feature information (e.g., number of family members, customer age, marital status, etc.) that is overlapped with the first user data may be hidden in the second training sample, such that the second user data can include only sample features (e.g., a stock holding, a stock return, etc.) that are not overlapped with the first user data.

FIG. 4 is a schematic flowchart illustrating a longitudinal federated learning according to some embodiments of the present disclosure. Process 400 may be performed by various nodes of the blockchain federation. In some embodiments, operations 410-460 may be performed by the federated learning module 250.

As shown in FIG. 4, the process 400 may include the following operations.

In 410, the initiator node may send the first representation data containing a sample list to the supervisor node, and the at least one participant node may send the second representation data containing a sample list to the supervisor node. For more information about the representation data and the sample list, please refer to operation 330 and their relevant descriptions.

In some embodiments, before operation 410, the participant nodes and the initiator node may pre-process the training data stored in the nodes. The pre-processing may include processing (e.g., deleting, refining based on other databases, etc.) training samples with abnormal values, missing values, overlapping values, and other abnormalities in the training data.

In 420, the supervisor node may determine the first training sample set based on the first representation data and the second representation data and send the first training sample to the initiator node and the at least one participant node.

Each training sample in the first training sample set may exist in both the first user data and the second user data. In some embodiments, the first training sample set may be represented by a training sample list, wherein each sample in the training sample list may include a portion of the training samples for which the sample identification information is overlapped in the first user data and the second user data.

In some implementations, the first user data of the initiator node may be represented as {Xᵢ^{A},Yᵢ^{A}}, i ∈ D_{A}, where Xᵢ^{A} represents a feature vector of the ith sample in the sample list D_{A}, and Yᵢ^{A} represents a label value of the feature Xᵢ^{A}. The second user data of the participant node may be represented as {Xᵢ^{B}}, i ∈ D_{B}, where Xᵢ^{B} represents a feature vector of the ith sample in the sample list D_{B}, and individual elements in Xᵢ^{A} and Xᵢ^{B} represent different meanings. Then, the first training sample set may be represented as {Xᵢ^{A},Xᵢ^{B},Yᵢ^{A}}, i ∈ D_{E}, where, D_{E}=D_{A}∩D_{B}.

In some embodiments, the first training sample set may also include a feature composition of the training samples. For example, the first training sample set may include sample features from the first user data and a portion of sample features from the second user data.

In some embodiments, the sending the first training sample set to the initiator node and the at least one participant node may mean that sending the sample list to the initiator node and the at least one participant node, i.e., only D_{E} needs to be fed to the initiator node and the at least one participant node.

In 430, the initiator node and the at least one participant node may determine corresponding training data based on the first training sample set, respectively.

The initiator node may determine the training data {Xᵢ^{A},Yᵢ^{A}}, i ∈ D_{E}, based on the sample list D_{E}. The at least one participant node may determine the training data {Xᵢ^{b}}i ∈ D_{E}, based on D_{E}.

In some embodiments, the first training sample set may also be proportionally divided into a training sample set and a test sample set. For more information about the training sample set and the test sample set, please refer to operation 350 and their relevant descriptions.

In some embodiments, after the at least one participant node and the initiator node determines the corresponding training data based on the first training sample set, respectively, at least one round of training may be performed on the conversion rate model based on the training data.

The conversion rate model of the initiator node may include a conversion rate model from the federated learning request. The conversion rate model of the participant nodes may be constructed based on the second user data. For example, the conversion rate model of the initiator node may be represented as u^{a}=Wₐ*xₐ, where xₐ represents the feature variables {Xᵢ^{A}} input to a machine learning model, i ∈ D_{E}, Wₐ represents a relevant parameter of xₐ, an initial value of wₐ may be recorded in the federal learning request (which may be randomly generated if not recorded), and u^{a} represents the output of the conversion rate model. Then, the conversion rate model of the participant nodes may be represented as {Xᵢ^{B}}, i ∈ D_{E}, where x b represents the feature variables {Xᵢ^{B}} input to the machine learning model, i ∈ D_{E}, W_{b} represents a relevant parameter of x_{b}, and u^{b} represents the output of the conversion rate model. An initial value of w_{b} may be a random value or a preset initial value (e.g., 1).

In each round of model training, the process 400 may include the operations.

In 440, the initiator node and the at least one participant node may determine intermediate results of the round of training based on the same training sample in the first training sample set and corresponding representation data, respectively, and send the intermediate result to the supervisor node.

The training based on the same training sample in the first training sample set may refer to that sample features input by the initiator node and the at least one participant node belong to the same sample. For example, in the round of training, the feature {Xᵢ^{A}} and the feature {Xᵢ^{B}} input to the different federated learning models separately may be features of the same sample, i.e., the i in {Xᵢ^{A}} and {Xᵢ^{B}} represent the same number.

The intermediate result may represent relevant data needed in iterating the conversion rate model. For example, the intermediate result may include an output of the conversion rate model after the sample features are input into the corresponding conversion rate model. For instance, the intermediate result of the initiator node may refer to the output u^{a} after the sample feature {Xᵢ^{A}} is input to the conversion rate model. The intermediate result of the participant node may refer to the output U^{b} after the sample feature {Xᵢ^{B}} is input to the conversion rate model.

In some embodiments, the intermediate result may be determined based on a target function during parameter iteration. Taking a linear regression as an example, the target function during parameter iteration may be as follows:

L=min(u^{a}+u^{b}−yₐ)²=min(wₐ·xₐ+W_{b}·x_{b}−yₐ)²

Then, based on the above target function, the iteration parameters (iteration gradient) of the training may be

$$\frac{\partial L}{\partial {w}_{a}} = 2 \cdot ( {u}^{b} + {u}^{a} - {y}_{a} ) \cdot {x}_{a} and \frac{\partial L}{\partial {w}_{b}} = 2 \cdot ( {u}^{b} + {u}^{a} - {y}_{a} ) \cdot {x}_{b} .$$

The iteration parameters and each parameter in the target function may be used as intermediate results.

In some embodiments, to avoid the direct storage of specific data (e.g., sample features, sample labels, etc.) by the supervisor node and guarantee the privacy of the data, the encryption of data based on the public key may include a homomorphic encryption. That is, the homomorphically encrypted data may be processed to obtain an output, and the output may be decrypted, the result being the same as the output result obtained by processing original unencrypted data using the same manner. At this point, the participant nodes may exchange the intermediate results with the initiator node, thereby the intermediate results sent to the supervisor node may be intermediate results that does not involve sample features, so that the supervisor node may not store the private data directly.

The target function may be encrypted based on the public key of the supervisor node, and the encrypted target function may be as follows:

[symbol]

L [symbol] =[[u^{a}+u^{b}−yₐ)²]]= [symbol] (u^{b})² [symbol] +[[(u^{a}−yₐ)²]]+2[[u^{b}]]u^{a}−yₐ)

Further, [[L]]=[[L_{b}]]+[[Lₐ]]+[[L_{ab}]] and [[d]]=[[u^{b}]]+[[u^{a}−yₐ]], and then the iteration parameters may be

$$〚 \frac{\partial L}{\partial {w}_{a}} 〛 = 2 〚 d 〛 \cdot {x}_{a} and 〚 \frac{\partial L}{\partial {w}_{b}} 〛 = 2 〚 d 〛 \cdot {x}_{b} .$$

In the iteration, the at least one participant node may need to calculate [[u^{b}]] and [[L_{b}]] and send [[u_{b}]] and [[L_{b}]] to the initiator node, and the initiator node may need to calculate [[u^{a}]], [[d]], and [[L]] and send [[d]] to the at least one participant node. The operations may cause the initiator node to compute the encrypted target function [[L]] and the iteration parameter

$$〚 \frac{\partial L}{\partial {w}_{a}} 〛 ,$$

and the participant nodes compute the iteration parameter

$$〚 \frac{\partial L}{\partial {w}_{b}} 〛 .$$

That is, the intermediate results may include the target function [[L]] and the iteration parameters

$$〚 \frac{\partial L}{\partial {w}_{a}} 〛 , 〚 \frac{\partial L}{\partial {w}_{b}} 〛 .$$

To further ensure data security, a random mask may be added to an iteration function when the iteration parameters are sent to the supervisor node. For example, the participant nodes may generate a random mask [[R_{b}]], at which point the intermediate result sent to the supervisor node may be

$$〚 \frac{\partial L}{\partial {w}_{b}} 〛 + 〚 {R}_{b} 〛 .$$

As another example, the initiator node may generate a random mask [[Rₐ]], at which point the intermediate result sent to the supervisor node may be

$$〚 \frac{\partial L}{\partial {w}_{a}} 〛 + 〚 {R}_{a} 〛$$

### and [[L]].

In 450, the supervisor node may determine the iteration parameters of the initiator node and at least one participant node based on the intermediate results and send the iteration parameters to corresponding nodes.

In some embodiments, when the supervisor node receives specific values directly, the supervisor node may perform a calculation of a loss function to determine the iteration parameters based on the specific values (e.g., calculating

$$\frac{\partial L}{\partial {w}_{a}} and \frac{\partial L}{\partial {w}_{b}}$$

with reference to the content of operation 440).

In some embodiments, when the supervisor node receives an encrypted intermediate result, the supervisor node may directly decrypt the intermediate result and send the decrypted result to the corresponding node. For example, the intermediate results may include [[L]],

$$〚 \frac{\partial L}{\partial {w}_{b}} 〛 + 〚 {R}_{b} 〛 and 〚 \frac{\partial L}{\partial {w}_{a}} 〛 + 〚 {R}_{a} 〛 ,$$

and the supervisor node may directly decrypt the intermediate results before sending

$$\frac{\partial L}{\partial {w}_{b}} + {R}_{b}$$

to the participant nodes and before sending

$$\frac{\partial L}{\partial {w}_{a}} + {R}_{a}$$

to the initiator node.

In 460, the initiator node and the at least one participant node may iterate the conversion rate model based on the iteration parameters.

The initiator node and the at least one participant node may update their respective wₐ and w_{b} based on the iteration parameters. For example, the participant nodes may determine an iteration gradient from

$$\frac{\partial L}{\partial {w}_{b}} + {R}_{b}$$

based on a specific value of R_{b} and determine a change value of w_{b} based on

$$\frac{\partial L}{\partial {w}_{b}}$$

and L, thus enabling iteration of w_{b}.

In some embodiments, when the model is tested, the initiator node may send the computed u^{a} and the label yₐ as an intermediate result to the supervisor node. The at least one participant node may send the computed U^{b} as an intermediate result to the supervisor node. The supervisor node may determine an accuracy of the trained model based on u^{a}, U^{b}, and yₐ.

In some embodiments, at least one round of model training may be performed until the accuracy of the model no longer increases after training, or a specified number of training rounds is reached, to complete the iteration.

In some embodiments, it is considered that the initiator node may have only a portion of the training samples that overlap with the second user data. To ensure the training effect, the initiator node may use the portion of the training data to be trained separately. For example, the model u^{a} may be trained based on the training data {Xᵢ^{A},Yᵢ^{A}},i ∈ D_{A} and i ∈ D_{A}, before the longitudinal learning, and the parameter wₐ of the trained model u^{a} may be used as the initial parameter of the longitudinal federated learning.

According to the manner of the longitudinal federated learning based on the blockchain federation provided in some embodiments of the present disclosure, other sample features in the second user data may be reasonably utilized to improve the accuracy of the conversion rate model. In addition, the information exchange of each node may be done without involving private data, which in turn ensures data security.

It should be noted that the above description of process 400 is for illustration purposes, and not intended to limit the scope of the present disclosure. For those skilled in the art, various variations or modifications may be made to the process 400 under the teaching of the present disclosure. However, the variations or modifications do not depart from the scope of the present disclosure.

FIG. 5 is a schematic flowchart illustrating a horizontal federated learning according to some embodiments of the present disclosure. Process 500 may be performed by various nodes of the blockchain federation. In some embodiments, operations 510-560 may be performed by the federated learning module 250.

As shown in FIG. 5, the process 500 may include the following operations.

In 510, the initiator node may send the first representation data containing a sample list to the supervisor node, and the at least one participant node may send the second representation data containing a sample list to the supervisor node.

For more information about operation 510, please refer to operations 330, and 410 and relevant description thereof.

In 520, the supervisor node may determine a second training sample set based on the first representation data and the second representation data, and send the second training sample set to the initiator node and the at least one participant node.

The second training sample set may include the first user data and non-overlapping training samples from the second user data. In some embodiments, the second training sample set may be characterized by a training sample list, wherein the samples in the training sample list may be a concatenation of the training samples from the first user data and the second user data.

Assuming that the first user data of the initiator node is represented as {Xᵢ^{A},Yᵢ^{A}}, i ∈ D_{A}, the second user data of the participant nodes may be represented as {Xᵢ^{A},Yᵢ^{A}}, i ∈ D_{C}, where Xᵢ^{A} represents the feature vector of the ith sample in the sample list D_{A}/D_{C}, and Yᵢ^{A} represents the label value of Xᵢ^{A}. Then, the second training sample set may be represented as, {Xᵢ^{A},Yᵢ^{A}}, i ∈ D_{F}, where the sample list D_{F} includes elements in D_{A} and D_{C} that are not overlapped.

In some embodiments, the sending the second training sample set to the initiator node and the at least one participant node may refer to simply sending the sample list to the initiator node and the at least one participant node, so that the initiator node and the at least one participant node exclude overlapped samples based on the sample list D_{F}.

In 530, the initiator node and the at least one participant node may determine corresponding training data based on the second training sample set respectively.

For the initiator node, the training data {Xᵢ^{A},Yᵢ^{A}}, i ∈ D_{F} and i ∈ D_{A}, may be determined according to D_{F}. For the participant nodes, the training data {Xᵢ^{A},Yᵢ^{A}}, i ∈ D_{F} and i ∈ D_{C}, may be determined according to D_{F}.

In some embodiments, the second training sample set may also be proportionally divided into a training sample set and a test sample set. For more information about the training sample set and the test sample set, please refer to operation 350 and the relevant descriptions thereof.

In some embodiments, after the initiator node and the at least one participant node determine the corresponding training data based on the second training sample set, respectively, at least one round of training of the conversion rate model may be performed based on the training data. The conversion rate model of the initiator node may be the same as the conversion rate model of the participant nodes. For example, the conversion rate model of the initiator node may be represented as uₐ=Wₐ xₐ, where xₐ represents the feature variable {Xᵢ^{A}}input to the machine learning model, i ∈ D_{F}, Wₐ represents a relevant parameter of xₐ, an initial value of wₐ may be recorded in the federal learning request (which may be randomly generated if not recorded), and uₐ represents the output of the conversion rate model.

In each round of model training, the process 500 may include the following operations.

In 540, the initiator node and the at least one participant node may determine the iteration parameters based on different training samples from the second training sample set, respectively, and send the iteration parameters to the supervisor node.

In each round of training, the initiator node and the at least one participant node may train a joint learning model several times based on the training data. In each round of training, the feature variables {Xᵢ^{A}}, i ∈ D_{F}, may be input into a conversion rate model to determine the model output uₐ and iterate the parameter wₐ based on the label values {yᵢ^{A}}, i ∈ D_{F}. The iteration parameter of each round of training may refer to the change value Δ wₐ of the parameter wₐ in the round of training. The iteration parameter of the initiator node may be Δ wₐ₁ and the iteration parameter of the participant node may be Δ wₐ₂.

In some embodiments, the number of training times in each round of training may be determined based on the number of samples. For example, if D_{F} includes 1000 groups of samples, D_{F} may be divided into 20 training rounds each with 50 iterations, and the specific number of iterations of the initiator node and the at least one participant node in each round of training may be determined based on a ratio of the number of samples.

In 550, the supervisor node may determine joint iteration parameters based on the iteration parameters and send the joint iteration parameters to the initiator node and the at least one participant node.

In some embodiments, the supervisor node may perform a combined operation (e.g., weighted summation, calculation of average, etc.) to determine the joint iteration parameters based on the iteration parameters of each node. For example, the joint iteration parameters may be Δ wₐ₃=(Δwₐ₁+Δwₐ₂)/2.

In 560, the initiator node and the at least one participant node may iterate the conversion rate model based on the joint iteration parameters.

The initiator node and the participant nodes may update the conversion rate model according to the joint iteration parameters. The conversion rate model of each node may have the same parameters after the update.

In some embodiments, when the model is tested, the initiator node and the at least one participant node may perform an individual calculation of the conversion rate model and send the accuracy to the supervisor node. The supervisor node may determine the accuracy of the trained model based on each accuracy (e.g., designate an average value of each accuracy as the accuracy of the trained model).

In some embodiments, at least one round of model training may be performed until the accuracy of the model no longer increases after training, or a specified number of training rounds is reached, to complete the iteration.

According to the horizontal federated learning method based on the blockchain federation provided in some embodiments of the present disclosure, the second user data may be reasonably used to populate the training samples to improve the accuracy of the conversion rate model.

It should be noted that the above description of process 500 is for illustration purposes, and not intended to limit the scope of application of the present disclosure. For those skilled in the art, various variations or modifications may be made to process 500 under the teaching of the present disclosure. However, the variations or modifications may be within the scope of the present disclosure.

FIG. 6 is a flowchart illustrating an exemplary manner for determining a training reward according to some embodiments of the present disclosure. As shown in FIG. 6, process 600 may include operations described below. In some embodiments, one or more operations of the process 600 shown in FIG. 6 may be implemented in the application scenario 100 of the system for improving a product conversion rate based on federated learning and blockchain shown in FIG. 1. For example, the process 600 shown in FIG. 6 may be stored in the storage device of the supervisor node 110 in the form of instructions and invoked and/or executed by the processor of the supervisor node 110. In some embodiments, operations 610-630 may be performed by the reward determination module 260.

In 610, a second accuracy determined based on the first user data in the federated training model may be obtained.

The second accuracy may refer to an accuracy of the trained conversion rate model when the conversion rate model is trained based on the first user data only. For example, the second accuracy may refer to various statistical indicators determined based on the sample label and the model output after a test sample is input to the conversion rate model trained based on the first user data only. For instance, the second accuracy may include a probability that the model output is the same as (or within a preset range of) the sample label, statistical indicators such as an average deviation, a standard deviation, a variance, and a model confidence level between the model output and the sample label, etc.

For the longitudinal federated learning, the second accuracy may refer to an accuracy of the conversion rate model without expanding the sample features. Relatively, the first accuracy may refer to an accuracy of the conversion rate model with expanded sample features. For example, for the user data and the conversion rate model shown in the process 400, the first accuracy may refer to a model accuracy determined based on the test data {Xᵢ^{A},Xᵢ^{B},Yᵢ^{A}}, i ∈ D_{E}′, the conversation rate model being trained based on {Xᵢ^{A},Xᵢ^{B},Yᵢ^{A}}, i ∉ D_{E}; the second accuracy may refer to a model accuracy determined based on the test data {Xᵢ^{A},Yᵢ^{A}}, i ∈ D_{E}′, the model being determined based on {Xᵢ^{A},Yᵢ^{A}}∈ D_{E}′ may be a test sample set in D_{E}.

For the horizontal federated learning, the second accuracy and the first accuracy may be determined based on a sample amount of the first user data and the second user data. For example, for the user data shown in operation 520, the first accuracy may refer to a model accuracy determined based on the test data {Xᵢ^{A},Yᵢ^{A}}, i ∈ D_{F}′, the conversion rate model being determined based on {Xᵢ^{A},Yᵢ^{A}}, i ∈ D_{F}; the second accuracy may refer to a model accuracy determined based on the test data {Xᵢ^{A},Yᵢ^{A}}, i ∈ D_{F}′, the conversion rate model being determined based on {Xᵢ^{A},Yᵢ^{A}},i ∈ D_{A}. D_{F}′ may be a test sample set in D_{E}. As another example, if the first training data contains 800 valid training samples, the second training data contains 400 valid training samples, and a ratio of training data to test data is 8:2, an accuracy of the federated learning model may be determined when a total of 640 iterations of the participant nodes and the initiator node are performed and designated as the second accuracy. An accuracy that is determined after the iterations are competed may be designated as the first accuracy.

In some embodiments, the first accuracy may be denoted as acc_{fed} and the second accuracy may be denoted as acc_{A}. If acc_{fed}≥acc_{A}, the federated learning may be determined to have an effect and training rewards may be allocated to each participant node. Conversely, the federated learning may be determined to have no effect.

In some embodiments, the federated learning request may include a model accuracy improvement goal. The model accuracy improvement goal may refer to an expectation of the initiator node to improve the model accuracy at the second accuracy. In some embodiments, the model accuracy improvement goal may be denoted as r. Then, the expected accuracy of the trained conversion rate model by the initiator node at the time of initiating the federated learning request may be acc_{A}+r.

In 620, a total training reward may be determined based on the first accuracy, the second accuracy, and the model accuracy improvement goal.

In some embodiments, the total training reward may be determined based on a correlation between the first accuracy, the second accuracy, and a desired accuracy.

When acc_{fed}≥acc_{A}+r, the trained conversion rate model may satisfy the expectation of the initiator node at this time. Then, an initial training reward minus a federated learning service fee may be taken as the total training reward for each participant node. The initial training reward may be denoted as R₀, and the federated learning service fee may be denoted as R₁. Then, the total training reward may be R=R₀−R₁, which may be denoted as R₂.

When acc_{A}+r>acc_{fed}>acc_{A}, the federated learning takes may effect but do not meet the expectation of the initiator node. Then, a reward of each participant node may be determined based on an accuracy improvement value. For example, the total training reward may be

$$R = {R}_{2} \times \frac{{acc}_{fed} - {acc}_{A}}{r} .$$

In 630, a training reward of each participant node may be determined based on the total training reward.

In some embodiments, the total training reward may be allocated based on the participant nodes to determine the training reward of each participant node. For example, the total training reward may be equally divided. As another example, the total training reward may be allocated based on a sample amount (e.g., the number of features in the longitudinal learning model, the number of valid samples in the horizontal learning model, etc.) provided by each participant node.

In some embodiments, the total training reward may be allocated based on a contribution degree of each participant node. That is, the supervisor node may determine the contribution degree of each participant node and determine the training reward of each participant node by allocating the total training reward proportionally based on the contribution degree of each participant node.

For each participant node of the horizontal federated learning, the contribution degree may be determined based on a sample amount of each participant node. For example, if the second user data of participant A contains 400 valid training samples and the second user data of participant B contains 600 valid training samples, a ratio of the contribution degree of participant A to the contribution degree of participant B may be 4:6.

In some embodiments, considering that the accuracy does not increase linearly with the sample amount, then the contribution of each participant may be determined based on an accuracy improvement due to the additional training samples. For example, if the first user data contains 800 valid training samples, the second accuracy may be determined when the conversion rate model is trained for the 800th time without considering the samples used for testing, and the first accuracy may be determined when the conversion rate model is trained for the 1800th time. A third accuracy, denoted as r₃, may be determined when the 1200th training is performed, and a fourth accuracy, denoted as r₄, may be determined when the 1400th training is performed. Then, an accuracy improvement from participant A may be

$${r}_{a} = \frac{{r}_{3} - {acc}_{A}}{2} ,$$

and an accuracy improvement from participant B may be

$${r}_{b} = \frac{{r}_{3} - {acc}_{A}}{2} + ( {r}_{4} - {r}_{3} ) = {r}_{4} - \frac{{r}_{3} + {acc}_{A}}{2} .$$

That is, a ratio of the contribution degree of participant A to the contribution degree of participant B may be rₐ:r_{b}.

For each participant node of the longitudinal federated learning, the contribution degree may be determined based on the number of additional feature dimensions of each participant node. For example, if the second user data of participant A contains 2 additional features and the second user data of participant B contains 1 additional feature, a ratio of the contribution degree of participant A to the contribution degree of participant B may be 2:1.

In some embodiments, considering that different feature dimensions have different improvements in accuracy, a contribution degree of a participant may be determined based on improvements in accuracy by different dimensions. For example, a feature of participant B may be {Xᵢ^{B}}, i ∈ D_{E}, then an accuracy of participant B may be a model accuracy r b determined based on the test data {Xᵢ^{A},Xᵢ^{B},Yᵢ^{A}}, i ∈ D_{E}′, the conversion rate model being determined based on {Xᵢ^{A},Xᵢ^{B},Yᵢ^{A}}, i ∈ E D_{E}. A feature of participant C may be {Xᵢ^{C}},i ∈ D_{E}, then an accuracy of participant C may a model accuracy r_{b} determined based on the test data {Xᵢ^{A},Xᵢ^{B},Yᵢ^{A}}, i ∈ D_{E}′, the conversion rate model being determined based on {Xᵢ^{A},Xᵢ^{B},Yᵢ^{A}}, i ∈ D_{E}. The first accuracy acc_{fed} may be the model accuracy determined based on the test data {Xᵢ^{A},Xᵢ^{B},Xᵢ^{C},Yᵢ^{A}}, i ∈ D_{E}′, the conversion rate model being determined based on {Xᵢ^{A},Xᵢ^{B},Yᵢ^{A}}, i ∈ D_{E}. The second accuracy acc_{A} may be the model accuracy determined based on the test data {Xᵢ^{A},Xᵢ^{B},Yᵢ^{A}}, i ∈ D_{E}′, the conversion rate model being determined based on {Xᵢ^{A},Yᵢ^{A}}, i ∈ D_{E}. Then, a ratio of the contribution degree of participant B to participant C may be (r_{b}−acc_{A}):(r_{c}−acc_{A}).

In some embodiments, when the federated learning strategy includes a combined strategy of the horizontal learning and the longitudinal learning, a ratio of the total training reward of each participant of the horizontal learning to the total training reward of each participant of the longitudinal learning may be a ratio of the model accuracy improved by the horizontal federated learning to the model accuracy improved by the longitudinal federated learning. For example, the conversion rate model may perform the horizontal federated learning before the longitudinal federated learning. The first accuracy acc_{fed} and the second accuracy acc_{A} when the horizontal federated learning is completed as described in the operation 610, and the first accuracy acc_{fed}′ and second accuracy acc_{A}′ when the longitudinal federated learning is completed may be determined as described in the operation 610. Then, the accuracy improvement formed by the horizontal federated learning may be r 1=acc_{fed}—acc_{A}, and the accuracy improvement formed by the longitudinal federated learning may be r₁=acc_{fed}′−acc_{A}′, where acc_{A}′=acc_{fed}. That is, a ratio of a contribution degree of the horizontal federated learning to a contribution degree of the longitudinal federated learning may be r₁:r₂.

In some embodiments, the supervisor node may allocate the total training reward R proportionally based on the ratio of the contribution degree of each participant node. For example, if the ratio of the contribution degree of participant node A and participant node B is c₁:c₂, the training reward of participant node A may be

$$R \times \frac{{c}_{1}}{{c}_{1} + {c}_{2}} ,$$

and the training reward of participant node B may be

$$R \times \frac{{c}_{1}}{{c}_{1} + {c}_{2}} .$$

In some embodiments, for the participant nodes of different types of learning strategies, the total training reward R may be allocated based on contribution degrees of the different types of learning strategies first, and then the different types of training rewards may be allocated based on the contribution degrees of the participant nodes.

In some embodiments, for the longitudinal federated learning, the supervisor node may adjust a reward allocation manner based on usage intentions of the participant nodes of the trained conversion rate model. For example, the supervisor node may ask the participant nodes about their intentions to use the trained conversion rate model, and if the participant nodes intend to use the trained conversion rate model, the participant nodes may pay the initiator node to invoke the conversion rate model, or the participant nodes may reduce an amount of the allocated training rewards, thereby sharing the conversion rate model with the initiator to further improve the model benefits.

In some embodiments, since the participant nodes may maliciously corrupt the effect of the conversion rate model (e.g., using some fake user data to reduce the prediction accuracy of the conversion rate model) while participating in the federated learning, resulting in useless results of the federated learning and wasting computational resources. Therefore, the participant nodes may be identified by the supervisor node to determine whether there is a malicious risk. For example, the supervisor node may determine a corresponding federated learning credit value based on the training reward of at least one participant node on the blockchain federation (e.g., using the training reward as the federated learning credit value). Next, the supervisor node may obtain a historical participation record of the at least one participant node, and evaluation scores determined by the smart contract for each participation in the federated learning. The historical participation record may include contribution degrees of the at least one participant node. Further, the supervisor node may determine whether there is a malicious risk based on an average of the federated learning credit values, an average of the contribution degrees, and an average of the evaluation scores. For example, the supervisor node may use a malicious risk value determination model to process the average of the federated learning credit values, the average of the contribution degrees, and the average of the evaluation scores to obtain a malicious risk value. For instance, the average of the federated learning credit values, the average of the contribution degrees, and the average of the evaluation scores may be input into the malicious risk value determination model, and the malicious risk value may be output by the malicious risk value determination model. The malicious risk value determination model may include a linear regression (LR) model, etc. Merely by way of example, the malicious risk value determination model may be L′=a×value₁+b×value₂+c×value₃, where value₁ represents the federated learning credit value, value₂ represents the average value of contribution degree, and value₃ represents the average value of evaluation score. According to the embodiment, the historical federated learning credit value, the average value of historical contribution degrees, and the average value of historical evaluation scores of historical participant nodes may be used as training data, and the model may be determined based on the training data and corresponding labels, such that the malicious risk value determination model may output the corresponding malicious risk value based on the average of the federated learning credit values, the average of the contribution degrees, and the average of the evaluation scores. In some embodiments, the labels (e.g., a label value of 1 if the participant is malicious and a label value of 0 if the participant is not malicious) corresponding to the training data may be determined by the historical initiator node based on actual usage of the historical conversion rate model and fed back to the supervisor node for determination.

According to the training reward determination method provided in some embodiments of the present disclosure, it is possible to determine whether the trained conversion rate model meets the expectations of the participant nodes and the training reward allocation may be determined based on the actual completion of the federated learning request. In addition, the training reward allocation of each participant node may be adjusted based on an actual contribution degree of each participant node, which improves the rationality of the training reward allocation.

It should be noted that the above description of process 600 is for illustration purposes, and not intended to limit the scope of application of the present disclosure. For those skilled in the art, various variations or modifications may be made to the process 600 under the teaching of the present disclosure. However, the variations or modifications may be within the scope of the present disclosure.

Some embodiments of the present disclosure also provide a non-transitory computer-readable storage medium including a set of instructions, when executed by a processor, a method for improving a product's conversion rate based on federal learning and blockchain may be implemented.

Possible beneficial effects of embodiments of the present disclosure include, but are not limited to, that: (1) Based on the method for improving a product conversion rate based on federated learning and blockchain provided by some embodiments of the present disclosure, more accurate processing results of user data to be mined can be determined, and training rewards of each participant node can be reasonably determined, thereby promoting the participation of each node of the blockchain federation in the federated learning. In addition, by writing the training rewards of each participant node into the blockchain, potential tampering by relevant persons may be prevented, which the fairness and the stability of the training reward system can be ensured. (2) Based on the longitudinal federated learning method based on the blockchain federation provided in some embodiments of the present disclosure, other sample features in the second user data can be reasonably utilized to improve the accuracy of the conversion rate model. In addition, the information exchange of each node can be done without involving private data, which in turn ensures data security. (3) Based on the horizontal federated learning method based on the blockchain federation provided in some embodiments of the present disclosure, the training samples populated by the second user data can be reasonably utilized to improve the accuracy of the conversion rate model. (4) Based on the training reward determination method provided in some embodiments of the present disclosure, it is possible to determine whether the trained conversion rate model meets the expectations of the participant nodes and determine the allocation of the training reward based on the actual completion of the federated learning request. In addition, the training reward allocation of each participant node can be adjusted based on the actual contribution of each participant node, which improves the rationality of the training reward allocation.

The basic concepts have been described above. Apparently, for those skilled in the field, the above detailed disclosure is merely examples, and does not constitute limitations of the disclosure. Although there is no clear explanation here, those skilled in the art may make various modifications, improvements, and amendments of present disclosure. The type of modifications, improvements, and amendments are recommended in present disclosure, so the modifications, improvements, and the amendments do not depart from the spirit and scope of the exemplary embodiment of the present disclosure.

At the same time, the present disclosure uses specific terms to describe the embodiments of the present disclosure. For example, “one embodiment”, “an embodiment”, and/or “some embodiments” mean a certain feature, structure, or characteristic of at least one embodiment of the present disclosure. Therefore, it is emphasized and should be noted that two or more references to “an embodiment” or “one embodiment” or “an alternative embodiment” in various parts of present disclosure are not necessarily all referring to the same embodiment. Further, certain features, structures, or features of one or more embodiments of the present disclosure may be combined.

Moreover, unless the claims are clearly stated, the order of processing elements and sequence, the use of the digital letters, or the use of other names in the present disclosure is not intended to define the order of processes and methods of the present disclosure. Although some embodiments of the disclosure currently considered useful are discussed in the above disclosure, it should be understood that the details is merely for illustration purposes, and the appended claims are not limited to the disclosed embodiments. Instead, the claims are intended to cover all modifications and equivalents combined with the substance and scope of the present disclosure. For example, although various components described above are implemented in a hardware device, the various components may also be implemented solely via a software scheme, e.g., an installation on an existing server or mobile device.

Similarly, it should be noted that in order to simplify the expression disclosed in the present disclosure and help the understanding of one or more embodiments, in the previous description of the embodiments of the present disclosure, a variety of features are sometimes combined into one embodiment, drawings or description thereof. However, this disclosure method does not mean that the characteristics required by the object of the present disclosure are more than the characteristics mentioned in the claims. Rather, claimed subject matter may lie in less than all features of a single foregoing disclosed embodiment.

In some embodiments, numbers expressing quantities of ingredients, properties, and so forth, configured to describe and claim certain embodiments of the application are to be understood as being modified in some instances by the term “about,” “approximate,” or “substantially”. Unless otherwise stated, “approximately”, “approximately” or “substantially” indicates that the number is allowed to vary by ±20%. Accordingly, in some embodiments, the numerical parameters used in the specification and claims are approximate values, and the approximate values may be changed according to characteristics required by individual embodiments. In some embodiments, the numerical parameters should be construed in light of the number of reported significant digits and by applying ordinary rounding techniques. Although the numerical domains and parameters used in the present disclosure are configured to confirm its range breadth, in the specific embodiment, the settings of such values are as accurately as possible within the feasible range.

For each patent, patent application, patent application publication and other materials referenced by the present disclosure, such as articles, books, instructions, publications, documentation, etc., hereby incorporated herein by reference. Except for the application history documents that are inconsistent with or conflict with the contents of the present disclosure, and the documents that limit the widest range of claims in the present disclosure (currently or later attached to the present disclosure). It should be noted that if a description, definition, and/or terms in the subsequent material of the present disclosure are inconsistent or conflicted with the content described in the present disclosure, the use of description, definition, and/or terms in this manual shall prevail.

Finally, it should be understood that the embodiments described herein are only configured to illustrate the principles of the embodiments of the present disclosure. Other deformations may also belong to the scope of the present disclosure. Thus, as an example, not limited, the alternative configuration of the present disclosure embodiment may be consistent with the teachings of the present disclosure. Accordingly, the embodiments of the present disclosure are not limited to the embodiments of the present disclosure clearly described and described.

What is claimed is:

1. A method for improving a product conversion rate based on federated learning and blockchain, applied to a supervisor node, wherein the method comprises:
in response to receiving a federated learning request sent by an initiator node, broadcasting the federated learning request within a blockchain federation, the initiator node storing first user data;
in response to obtaining a response to the federated learning request from at least one node in the blockchain federation, determining at least one participant node, wherein each participant node stores second user data;
obtaining first representation data related to the first user data from the initiator node and second representation data related to the second user data from the at least one participant node;
determining a federated learning strategy corresponding to the federated learning request based on the first representation data and the second representation data; and
coordinating the initiator node and the at least one participant node for federated learning based on the federated learning strategy to generate a trained conversion rate model, the trained conversion rate model being configured to determine, based on user data of a target user, a prediction outcome of the target user obtaining a preset product.

2. The method of claim 1, wherein the method further includes:
determining a training reward of each participant node based on a first accuracy of the trained conversion rate model, and writing the training reward to the blockchain.

3. The method of claim 1, wherein the determining a federated learning strategy corresponding to the federated learning request based on the first representation data and the second representation data includes:
determining a feature dimension similarity and a sample repetition based on the first representation data and the second representation data; and
determining the federated learning strategy from a longitudinal federated learning strategy and a horizontal federated learning strategy based on the feature dimension similarity and the sample repetition.

4. The method of claim 3, wherein when the longitudinal federated learning strategy is used as the federated learning strategy, the coordinating the initiator node and the at least one participant node for federated learning based on the federated learning strategy includes:
determining a first training sample set based on the first representation data and the second representation data, wherein each training sample in the first training sample set exists in both the first user data and the second user data;
sending the first training sample set to the initiator node and the at least one participant node, such that the initiator node and the at least one participant node determine corresponding training data based on the first training sample set respectively; and
performing at least one round of model training based on the training data, wherein in each round of model training:
obtaining intermediate results of the round of model training, the intermediate results being determined based on a same training sample in the first training sample set and corresponding representation data by the initiator node and the at least one participant node respectively; and
determining, based on the intermediate results, iteration parameters of the initiator node and the at least one participant node and sending the iteration parameters to corresponding nodes, such that the initiator node and the at least one participant node iterate the conversion rate model based on the iteration parameters.

5. The method of claim 3, wherein when the horizontal federated learning strategy is used as the federated learning strategy, the coordinating the initiator node and the at least one participant node for federated learning based on the federated learning strategy includes:
determining a second training sample set based on the first representation data and the second representation data, wherein the second training sample set includes the first user data and non-overlapping training samples of the second user data;
sending the second training sample set to the initiator node and the at least one participant node, such that the initiator node and the at least one participant node determine corresponding training data based on the second training sample set, respectively; and
performing at least one round of model training based on the training data, wherein in each round of model training:
obtaining iteration parameters of the round of model training, the iteration parameters being determined based on different training samples from the second training sample set by the initiator node and the at least one participant node respectively; and
determining joint iteration parameters based on the iteration parameter and sending the joint iteration parameter to the initiator node and each participant node, such that the initiator node and the each participant node iterate the conversion rate model based on the joint iteration parameters, respectively.

6. The method of claim 2, wherein the federated learning request includes a model accuracy improvement goal, and the determining a training reward of each participant node based on a first accuracy of the trained conversion rate model, and the writing the training reward to the blockchain include:
obtaining a second accuracy of the federated learning related to the conversion rate model that is determined based on the first user data;
determining a total training reward based on the first accuracy, the second accuracy, and the model accuracy improvement goal; and
determining a training reward of the each participant node based on the total training reward.

7. The method of claim 6, wherein the determining a training reward of the each participant node based on the total training reward includes:
determining a contribution degree of the each participant node; and
determining the training reward of the each participant node by allocating, based on the contribution degree of the each participant node, the total training reward proportionally.

8. The method of claim 1, wherein the federated learning request includes an initial training reward, the initial training reward including a federated learning service fee and a total training reward of the at least one participant node.

9. The method of claim 1, wherein the method further includes:
receiving user data to be mined sent by the initiator node;
determining, at least based on the user data to be mined, a processing result of the user data to be mined by the conversion rate model; and
sending the processing result to the initiator node.

10. A system for improving a product conversion rate based on federated learning and blockchain, comprising
at least one storage medium, the storage medium including an instruction set configured to improve the product conversion rate based on the federated learning and the blockchain;
at least one processor, the at least one processor in communication with the at least one storage medium, wherein, when executing the instruction set, the at least one processor is configured to:
in response to receiving a federated learning request sent by an initiator node, broadcast the federated learning request within a blockchain federation, the initiator node storing first user data;
in response to obtaining a response to the federated learning request from at least one node in the blockchain federation, determine at least one participant node, wherein each participant node stores second user data;
obtain first representation data related to the first user data from the initiator node and second representation data related to the second user data from the at least one participant node;
determine a federated learning strategy corresponding to the federated learning request based on the first representation data and the second representation data; and
coordinate the initiator node and the at least one participant node for federated learning based on the federated learning strategy to generate a trained conversion rate model, the trained conversion rate model being configured to determine, based on user data of a target user, a predicted outcome of the target user obtaining a preset product.

11. The system of claim 10, wherein the at least one processor is further configured to:
determining a training reward of each participant node based on a first accuracy of the trained conversion rate model, and writing the training reward to the blockchain.

12. A system for improving a product conversion rate based on federated learning and blockchain, comprising a blockchain federation including:
an initiator node configured to initiate a federated learning request, the initiator node storing first user data;
at least one participant node configured to receive the federated learning request, wherein each participant node stores second user data; and
a supervisor node in communication with the initiator node and the at least one participant node, wherein the supervisor node is configured to:
obtain first representation data related to the first user data from the initiator node and second representation data related to the second user data from the at least one participant node;
determine a federated learning strategy corresponding to the federated learning request based on the first representation data and the second representation data; and
coordinate the initiator node and the at least one participant node for federated learning based on the federated learning strategy to generate a trained conversion rate model, the trained conversion rate model being configured to determine, based on user data of a target user, a predicted outcome of the target user obtaining a preset product.

13. The system of claim 12, wherein the supervisor node is further configured to:
determining a training reward of each participant node based on a first accuracy of the trained conversion rate model, and writing the training reward to the blockchain.

14. The system of claim 12, wherein to determine a federated learning strategy corresponding to the federated learning request based on the first representation data and the second representation data, the supervisor node is further configured to:
determine a feature dimension similarity and a sample repetition based on the first representation data and the second representation data; and
determine the federated learning strategy from a longitudinal federated learning strategy and a horizontal federated learning strategy based on the feature dimension similarity and the sample repetition.

15. The system of claim 14, wherein when the longitudinal federated learning strategy is used as the federated learning strategy, to coordinate the initiator node and the at least one participant node for federated learning based on the federated learning strategy, the supervisor node is further configured to:
determine a first training sample set based on the first representation data and the second representation data, wherein each training sample in the first training sample set exists in both the first user data and the second user data; and
send the first training sample set to the initiator node and the at least one participant node, such that the initiator node and the at least one participant node determine corresponding training data based on the first training sample set respectively; and
perform at least one round of model training based on the training data, wherein in each round of model training, the supervisor node is further configured to:
obtain intermediate results of the round of model training, the intermediate results being determined based on a same training sample in the first training sample set and corresponding representation data by the initiator node and the at least one participant node respectively; and
determine, based on the intermediate results, iteration parameters of the initiator node and the at least one participant node and sending the iteration parameters to corresponding nodes, such that the initiator node and the at least one participant node iterate the conversion rate model based on the iteration parameters.

16. The system of claim 14, wherein when the horizontal federated learning strategy is used as the federated learning strategy, to coordinate the initiator node and the at least one participant node for federated learning based on the federated learning strategy, the supervisor node is further configured to:
determine a second training sample set based on the first representation data and the second representation data, wherein the second training sample set includes the first user data and non-overlapping training samples of the second user data;
send the second training sample set to the initiator node and the at least one participant node, such that the initiator node and the at least one participant node determine corresponding training data based on the second training sample set, respectively; and
perform at least one round of model training based on the training data, wherein in each round of model training, the supervisor node is further configured to:
obtain iteration parameters of the round of model training, the iteration parameters being determined by the initiator node and the at least one participant node based on different training samples from the second training sample set respectively; and
determine joint iteration parameters based on the iteration parameter and sending the joint iteration parameter to the initiator node and each participant node, such that the initiator node and the each participant node iterate the conversion rate model based on the joint iteration parameters, respectively.

17. The system of claim 13, wherein the federated learning request includes a model accuracy improvement goal, and to determine a training reward of each participant node based on a first accuracy of the trained conversion rate model, and to write the training reward to the blockchain, the supervisor node is further configured to:
obtain a second accuracy of the federated learning related to the conversion rate model that is determined based on the first user data;
determine a total training reward based on the first accuracy, the second accuracy, and the model accuracy improvement goal; and
determine a training reward of the each participant node based on the total training reward.

18. The system of claim 17, wherein to determine a training reward of the each participant node based on the total training reward, the supervisor node is further configured to:
determine a contribution degree of the each participant node; and
determine the training reward of the each participant node by allocating, based on the contribution degree of the each participant node, the total training reward proportionally.

19. The system of claim 12, wherein the federated learning request includes an initial training reward, the initial training reward including a federated learning service fee and a total training reward of the at least one participant node.

20. The system of claim 12, wherein the supervisor node is further configured to:
receive user data to be mined sent by the initiator node;
determine, at least based on the user data to be mined, a processing result of the user data to be mined by the conversion rate model, and
send the processing result to the initiator node.
